(19) United States
(12) Patent Application Publication
(10) Pub. No.: US 2013/0004708 A1
(43) Pub. Date: Jan. 3, 2013

(54) MOLDING APPARATUS, METHOD OF FORMING MOLDED PRODUCT, AND MOLDED PRODUCT

(75) Inventors: Shun Kayama, Saitama (JP); Yukiko Shimizu, Saitama (JP); Atsuhide Hanyu, Kanagawa (JP); Susumu Hoshino, Tokyo (JP); Keisuke Kawamura, Tokyo (JP)

(73) Assignee: SONY CORPORATION, Tokyo (JP)

(21) Appl. No.: 13/530,542

(22) Filed: Jun. 22, 2012

(30) Foreign Application Priority Data
Jun. 29, 2011 (JP) 2011-144598
Sep. 22, 2011 (JP) 2011-207914
Dec. 14, 2011 (JP) 2011-273682

(51) Int. Cl. B29C 45/26; B32B 3/24; B29C 45/00; B29C 45/03; B29C 45/72

(52) U.S. Cl. 428/131; 425/577; 425/547; 425/553; 264/138

(57) ABSTRACT

A molding apparatus includes a cavity mold, a core mold, a core pin, and a cavity pin. After molten resin has been filled in a cavity, at least one of the core pin and the cavity pin is moved to be pressed onto the molten resin so that a part of the molten resin is compressed before the molten resin is cured, and a molded hole is formed by cutting off the compressed part of the molten resin by moving the core pin and the cavity pin.

### BACKGROUND

The present disclosure relates to a technical field of a molding apparatus, a method of forming a molded product, and a molded product. Specifically, the present disclosure relates to a technical field of forming a molded hole by moving at least one of a core pin and a cavity pin so that a part of molten resin that has been compressed before the molten resin is cured is cut off, to thereby prevent generation of weld lines without involving high manufacturing cost.

There have been provided molding apparatuses including an injection-molding mold assembly formed of a cavity mold to function as a fixed mold and a core mold to function as a movable mold, in which molten resin is filled in a cavity (space) formed by fitting the cavity mold against the core mold so as to form a molded product.

In the injection-molding mold assembly of such molding apparatuses, depending on a shape of the cavity, there is a risk that large weld lines are generated when the molten resin filled in the cavity is cured by being cooled. For example, when a projecting portion is provided on one of the molds, the molten resin is fluidized around the projecting portion. Thus, weld lines are more liable to be formed at a confluence of the molten resin fluidized in different directions. The weld lines are enlarged by gas and air generated from the molten resin and existing in a periphery of the projecting portion around which the molten resin merges.

Generation of the weld lines is suppressed by applying a higher quantity of heat to the molten resin through intermediation of the injection-molding mold assembly.

In terms of this, in some molding apparatuses in related art, a plurality of flow paths are formed around the cavity in the injection-molding mold assembly so as to heat molten resin through intermediation of the injection-molding mold assembly by supplying heating medium to the plurality of flow paths when the molten resin is filled in the cavity (refer to, for example, Japanese Patent Application Laid-open No. 2006-82267; hereinafter, referred to as Patent Document 1).

### SUMMARY

However, regarding the molding apparatus disclosed in Patent Document 1, when molten resin is filled in the cavity of the injection-molding mold assembly, it is necessary to use a large-scale heating apparatus configured to perform rapid heating by supplying the heating medium to the plurality of flow paths. Thus, there is a problem of high capital investment cost, which leads to an increase in manufacturing cost of the molded product.

In view of the above-mentioned circumstances, there is a need for providing a molding apparatus, a method of forming a molded product, and a molded product which prevent generation of weld lines without involving high manufacturing cost.

First, according to an embodiment of the present disclosure, there is provided a molding apparatus, including:

a cavity mold fixed at a predetermined position;

a core mold configured to be fitted against and clamped to the cavity mold so that a cavity in which molten resin is to be filled through a gate is formed;

a core pin supported to be movable in a direction in which the cavity mold and the core mold are moved toward and away from each other in the core mold and configured to form a molded hole in a molded product to be formed by curing the molten resin that has been filled in the cavity; and

a cavity pin supported to be movable in the direction in which the cavity mold and the core mold are moved toward and away from each other in the cavity mold, having a central axis corresponding to a central axis of the core pin, and configured to form the molded hole together with the core pin, in which

after the molten resin has been filled in the cavity, at least one of the core pin and the cavity pin is moved to be pressed onto the molten resin so that a part of the molten resin is compressed before the molten resin is cured, and

the molded hole is formed by cutting off the compressed part of the molten resin by moving the core pin and the cavity pin.

Thus, according to this molding apparatus, after the molten resin has been filled in the cavity, the core pin and the cavity pin compress and cut off the part of the molten resin. In this way, the molded hole is formed in the molded product.

Second, in the above-mentioned molding apparatus, it is desired that

the core mold be provided with a filling recessed portion which forms a part of the cavity and in which the molten resin is to be filled,

the cavity pin have a distal end portion provided with a holding recessed portion configured to hold a cut-off piece remaining after the molded hole has been formed, and

after the core mold has been separated from the cavity mold, the molded product remain in the filling recessed portion and adhere to the core mold, and the cut-off piece remain in the holding recessed portion and adhere to the cavity pin.

After the core mold has been separated from the cavity mold, the molded product remains in the filling recessed portion and adheres to the core mold, and the cut-off piece remains in the holding recessed portion and adheres to the cavity pin. With this, the molded product and the cut-off piece are respectively taken out from the core mold and the cavity pin separate from each other.

Third, it is desired that the above-mentioned molding apparatus further include:

a sucker configured to take out, from the cavity pin, the cut-off piece remaining after the molded hole has been formed; and

a measurer configured to measure suction pressure of the sucker at the time when the sucker sucks the cut-off piece.

Further, it is desired that the core mold and the cavity mold be clamped to each other when the measurer detects suction pressure equal to or more than a predetermined value.

By clamping the core mold and the cavity mold to each other when the measurer detects suction pressure equal to or more than a predetermined value, the core mold and the cavity mold are not clamped to each other as long as the cut-off piece remains on the cavity pin.

Fourth, it is desired that the above-mentioned molding apparatus further include:

a first slider which includes a core-pin cam portion engaged to be slidable with respect to the core pin so that the core pin is moved and which is supported to be movable in a predetermined direction in the core mold; and

a second slider which includes a cavity-pin cam portion engaged to be slidable with respect to the cavity pin so that the cavity pin is moved and which is supported to be movable in a predetermined direction in the cavity mold.

By providing the first slider which includes the core-pin cam portion engaged to be slidable with respect to the core pin so that the core pin is moved and the second slider which includes the cavity-pin cam portion engaged to be slidable with respect to the cavity pin so that the cavity pin is moved, the core pin and the cavity pin are respectively moved when the first slider and the second slider are operated.

Fifth, it is desired that the above-mentioned molding apparatus further include:

a first urging spring configured to urge the core pin in a direction in which the core pin comes into contact with the core-pin cam portion of the first slider; and

a second urging spring configured to urge the cavity pin in a direction in which the cavity pin comes into contact with the cavity-pin cam portion of the second slider.

By providing the first urging spring configured to urge the core pin in the direction in which the core pin comes into contact with the core-pin cam portion and the second urging spring configured to urge the cavity pin in the direction in which the cavity pin comes into contact with the cavity-pin cam portion, the core pin is pressed onto the core-pin cam portion by an urging force of the first urging spring, and the cavity pin is pressed onto the cavity-pin cam portion by an urging force of the second urging spring.

Sixth, in the above-mentioned molding apparatus, it is desired that a cutting edge projected to the cavity pin side be formed along an outer peripheral portion of a distal end portion of the core pin.

By forming the cutting edge projected to the cavity pin side along the outer peripheral portion of the distal end portion of the core pin, a condition of a cut surface is satisfactorily secured when the molded hole is formed in the molded product.

Seventh, in the above-mentioned molding apparatus, it is desired that a cutting portion projected to the core pin side be formed along an outer peripheral portion of a distal end portion of the cavity pin.

By forming the cutting portion projected to the core pin side along the outer peripheral portion of the distal end portion of the cavity pin, the condition of the cut surface is more satisfactorily secured when the molded hole is formed in the molded product.

Eighth, it is desired that the above-mentioned molding apparatus further include a heater configured to suppress a cooling speed of the molten resin to be filled in the cavity.

By providing the heater configured to suppress a cooling speed of the molten resin to be filled in the cavity, a cooling speed of the molten resin filled in the cavity is suppressed. With this, a time period until the molten resin is cured can be prolonged.

Ninth, it is desired that the above-mentioned molding apparatus further include:

a cutting pin supported to be movable in the direction in which the cavity mold and the core mold are moved toward and away from each other in the core mold and configured to cut off the molten resin at an interface between the gate and the cavity; and

a receiving pin supported to be movable in the direction in which the cavity mold and the core mold are moved toward and away from each other in the cavity mold and having a central axis corresponding to a central axis of the cutting pin,

Further, it is desired that the cutting pin cut off the molten resin at the interface between the gate and the cavity when the molded hole is formed by cutting off the compressed part of the molten resin.

By cutting off the molten resin with the cutting pin at the interface between the gate and the cavity when the molded hole is formed by cutting off the compressed part of the molten resin, it is unnecessary to perform a post-step of cutting off the molded product from the molten resin filled and cured in the gate.

Tenth, it is desired that the above-mentioned molding apparatus further include:

a cutting pin supported to be movable in the direction in which the cavity mold and the core mold are moved toward and away from each other in the core mold and configured to cut off the molten resin at an interface between the gate and the cavity; and

a receiving pin supported to be movable in the direction in which the cavity mold and the core mold are moved toward and away from each other in the cavity mold and having a central axis corresponding to a central axis of the cutting pin.

Further, it is desired that the first slider be provided with a cutting-pin cam portion engaged to be slidable with respect to the cutting pin so that the cutting pin is moved.

Still further, it is desired that the second slider be provided with a receiving-pin cam portion engaged to be slidable with respect to the receiving pin so that the receiving pin is moved.

Yet further, it is desired that the core pin and the cutting pin be configured to be movable simultaneously with each other in accordance with movement of the first slider.

Yet further, it is desired that the cavity pin and the receiving pin be configured to be movable simultaneously with each other in accordance with movement of the second slider.

Yet further, it is desired that the cutting pin cut off the molten resin at the interface between the gate and the cavity when the molded hole is formed by cutting off the compressed part of the molten resin.

By configuring the core pin and the cutting pin to be movable simultaneously with each other in accordance with the movement of the first slider and by configuring the cavity pin and the receiving pin to be movable simultaneously with each other in accordance with the movement of the second slider, two sliders of the first slider and the second slider move four pins of the core pin, the cutting pin, the cavity pin, and the receiving pin.

Eleventh, in the above-mentioned molding apparatus, it is desired that the part of the molten resin, which has been compressed and cut off, be formed as a cut-off piece, the cut-off piece being configured to be inserted in the molded hole by moving the core pin and the cavity pin and to be held in the molded hole.

By configuring the cut-off piece to be inserted in the molded hole by moving the core pin and the cavity pin and to be held in the molded hole, the cavity pin or the core pin need not be provided with a part configured to hold the cut-off piece.

Twelfth, in the above-mentioned molding apparatus, it is desired that the cut-off piece held in the molded hole be configured to be taken out from the cavity together with the molded product.

By configuring the cut-off piece held in the molded hole to be taken out from the cavity together with the molded product, the molded product and the cut-off piece are taken out from the cavity in a single step.

Thirteenth, it is desired that the above-mentioned molding apparatus further include a fixing sleeve formed into a cylindrical shape extending in the direction in which the cavity mold and the core mold are moved toward and away from each other, and having one axial end portion provided with an inclined surface forming portion which is inclined with respect to the direction in which the cavity mold and the core mold are moved toward and away from each other and which is configured to form an inclined surface with respect to the molded product.

Further, it is desired that the fixing sleeve be fixed in one of the core mold and the cavity mold under a state in which the inclined surface forming portion is positioned in the cavity.

Still further, it is desired that one of the core pin and the cavity pin be supported to be slidable with respect to the fixing sleeve under a state of being inserted in the fixing sleeve.

By fixing the fixing sleeve in one of the core mold and the cavity mold under the state in which the inclined surface forming portion is positioned in the cavity and by supporting one of the core pin and the cavity pin to be slidable with respect to the fixing sleeve under the state of being inserted in the fixing sleeve, the inclined surface with respect to the molded product is formed with the fixing sleeve. Simultaneously, the molded hole is formed in the molded product with the core pin and the cavity pin.

Fourteenth, according to another embodiment of the present disclosure, there is provided another molding apparatus, including:

a cavity mold fixed at a predetermined position;

a core mold configured to be fitted against and clamped to the cavity mold so that a cavity in which molten resin is to be filled through a gate is formed;

a core pin supported to be movable in a direction in which the cavity mold and the core mold are moved toward and away from each other in the core mold and configured to form a resin compressed portion by compressing a part of the molten resin that has been filled in the cavity;

a cavity pin supported to be movable in the direction in which the cavity mold and the core mold are moved toward and away from each other in the cavity mold, having a central axis corresponding to a central axis of the core pin, and configured to form the resin compressed portion together with the core pin; and

a punch configured to be movable in the direction in which the cavity mold and the core mold are moved toward and away from each other and to form a molded hole in a molded product by cutting off the resin compressed portion.

In this molding apparatus, after the molten resin has been filled in the cavity, at least one of the core pin and the cavity pin is moved to be pressed onto the molten resin so that the part of the molten resin is compressed to be formed as the resin compressed portion before the molten resin is cured, and

the molded hole is formed by cutting off the resin compressed portion by the punch.

Thus, according to this molding apparatus, after the molten resin has been filled in the cavity, the at least one of the core pin and the cavity pin compresses and cuts off the part of the molten resin. In this way, the molded hole is formed in the molded product.

Fifteenth, it is desired that the above-mentioned molding apparatus further include a slider which includes a cam portion engaged to be slidable with respect to the at least one of the core pin and the cavity pin so that the at least one of the core pin and the cavity pin is moved and which is supported to be movable in a predetermined direction in the at least one of the core pin and the cavity pin.

By providing the slider which is engaged to be slidable with respect to the at least one of the core pin and the cavity pin so that the at least one of the core pin and the cavity pin is moved, the at least one of the core pin and the cavity pin is moved when the slider is operated.

Sixteenth, it is desired that the above-mentioned molding apparatus further include an urging spring configured to urge the at least one of the core pin and the cavity pin in a direction in which the at least one of the core pin and the cavity pin comes into contact with the cam portion of the slider.

By providing the urging spring configured to urge the at least one of the core pin and the cavity pin in the direction in which the at least one of the core pin and the cavity pin comes into contact with the cam portion of the slider, the at least one of the core pin and the cavity pin is pressed onto the cam portion by an urging force of the urging spring.

Seventeenth, according to another embodiment of the present disclosure, there is provided a method of forming a molded product, including:

forming a cavity with a cavity mold fixed at a predetermined position and a core mold configured to be fitted against and clamped to the cavity mold;

filling molten resin through a gate into the cavity;

compressing a part of the molten resin by pressing at least one of a core pin and a cavity pin onto the molten resin before the molten resin is cured, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the compressed part of the molten resin by moving the core pin and the cavity pin.

Thus, in this method of forming a molded product, after the molten resin has been filled in the cavity, the core pin and the cavity pin compress and cut off the part of the molten resin. In this way, the molded hole is formed.

Eighteenth, according to another embodiment of the present disclosure, there is provided a molded product obtained by:

compressing a part of molten resin by pressing at least one of a core pin and a cavity pin onto the molten resin before the molten resin is cured, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the compressed part of the molten resin by moving the core pin and the cavity pin.

Thus, in this molded product, after the molten resin has been filled in the cavity, the core pin and the cavity pin compress and cut off the part of the molten resin. In this way, the molded hole is formed.

Nineteenth, according to another embodiment of the present disclosure, there is provided another method of forming a molded product, including:

forming a cavity with a cavity mold fixed at a predetermined position and a core mold configured to be fitted against and clamped to the cavity mold;

filling molten resin through a gate into the cavity;

pressing at least one of a core pin and a cavity pin onto the molten resin before the molten resin is cured so that a part of the molten resin is compressed to be formed as a resin compressed portion, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole in a molded product by cutting off the resin compressed portion by a punch.

Thus, in this method of forming a molded product, after the molten resin has been filled in the cavity, the at least one of the core pin and the cavity pin compresses and cuts off the part of the molten resin. In this way, the molded hole is formed.

Twentieth, according to another embodiment of the present disclosure, there is provided another molded product obtained by:

pressing at least one of a core pin and a cavity pin onto molten resin before the molten resin is cured so that a part of the molten resin is compressed to be formed as a resin compressed portion, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the resin compressed portion by a punch.

Thus, in this molded product, after the molten resin has been filled in the cavity, the at least one of the core pin and the cavity pin compresses and cuts off the part of the molten resin. In this way, the molded hole is formed.

A molding apparatus according to a first embodiment of the present disclosure includes:

a cavity mold fixed at a predetermined position;

a core mold configured to be fitted against and clamped to the cavity mold so that a cavity in which molten resin is to be filled through a gate is formed;

a core pin supported to be movable in a direction in which the cavity mold and the core mold are moved toward and away from each other in the core mold and configured to form a molded hole in a molded product to be formed by curing the molten resin that has been filled in the cavity; and

a cavity pin supported to be movable in the direction in which the cavity mold and the core mold are moved toward and away from each other in the cavity mold, having a central axis corresponding to a central axis of the core pin, and configured to form the molded hole together with the core pin.

In this molding apparatus, after the molten resin has been filled in the cavity, at least one of the core pin and the cavity pin is moved to be pressed onto the molten resin so that a part of the molten resin is compressed before the molten resin is cured, and

the molded hole is formed by cutting off the compressed part of the molten resin by moving the core pin and the cavity pin.

Thus, the molded hole is formed after the molten resin has been filled in the cavity, and hence it is unnecessary to use a large-scale heating apparatus or the like configured to perform rapid heating so as to prevent generation of weld lines. Thus, generation of weld lines is prevented without involving high manufacturing cost.

In the molding apparatus according to a second embodiment of the present disclosure,

the core mold is provided with a filling recessed portion which forms a part of the cavity and in which the molten resin is to be filled,

the cavity pin has a distal end portion provided with a holding recessed portion configured to hold a cut-off piece remaining after the molded hole has been formed, and

after the core mold has been separated from the cavity mold, the molded product remains in the filling recessed portion and adheres to the core mold, and the cut-off piece remains in the holding recessed portion and adheres to the cavity pin.

In this way, the molded product and the cut-off piece are respectively taken out from the core mold and the cavity pin separate from each other. Thus, the molded product and the cut-off piece can be simultaneously taken out. As a result, the molding operation of the molded product can be performed within a shorter operating time period.

The molding apparatus according to a third embodiment of the present disclosure further includes:

a sucker configured to take out, from the cavity pin, the cut-off piece remaining after the molded hole has been formed; and

a measurer configured to measure suction pressure of the sucker at the time when the sucker sucks the cut-off piece.

In this molding apparatus, the core mold and the cavity mold are clamped to each other when the measurer detects suction pressure equal to or more than a predetermined value.

Thus, the core mold and the cavity mold are not clamped to each other as long as the cut-off piece remains on the cavity pin. As a result, the cut-off piece is prevented from being nipped between the core mold and the cavity mold.

The molding apparatus according to a fourth embodiment of the present disclosure further includes:

a first slider which includes a core-pin cam portion engaged to be slidable with respect to the core pin so that the core pin is moved and which is supported to be movable in a predetermined direction in the core mold; and

a second slider which includes a cavity-pin cam portion engaged to be slidable with respect to the cavity pin so that the cavity pin is moved and which is supported to be movable in a predetermined direction in the cavity mold.

In this way, the core pin and the cavity pin can be reliably moved with a simple mechanism. As a result, the mechanism of the molding apparatus can be simplified and manufacturing cost can be reduced.

The molding apparatus according to a fifth embodiment of the present disclosure further includes:

a first urging spring configured to urge the core pin in a direction in which the core pin comes into contact with the core-pin cam portion of the first slider; and

a second urging spring configured to urge the cavity pin in a direction in which the cavity pin comes into contact with the cavity-pin cam portion of the second slider.

With this, high positional accuracies of the core pin and the cavity pin respectively with respect to the core mold and the cavity mold can be secured. As a result, the core pin and the cavity pin can be operated with higher reliability during the molding operation of the molded product.

In the molding apparatus according to a sixth embodiment of the present disclosure, a cutting edge projected to the cavity pin side is formed along an outer peripheral portion of a distal end portion of the core pin.

With this, when the molded hole is formed in the molded product by the cutting edge, a condition of a cut surface is satisfactorily secured. As a result, the molded hole can be processed with higher accuracy.

In the molding apparatus according to a seventh embodiment of the present disclosure, a cutting portion projected to the core pin side is formed along an outer peripheral portion of a distal end portion of the cavity pin.

With this, when the molded hole is formed in the molded product by the cutting portion, the condition of the cut surface is more satisfactorily secured. As a result, the molded hole can be processed with much higher accuracy.

The molding apparatus according to an eighth embodiment of the present disclosure further includes a heater configured to suppress a cooling speed of the molten resin to be filled in the cavity.

In this way, a time period until the molten resin is cured can be prolonged. With this, a part of the molten resin can be compressed in an optimum state, that is, an uncured state. In addition, in this optimum state, that is, the uncured state, the molded hole is formed by cutting off the part of the molten resin. As a result, the molded hole can be processed with higher accuracy.

The molding apparatus according to a ninth embodiment of the present disclosure further includes:

a cutting pin supported to be movable in the direction in which the cavity mold and the core mold are moved toward and away from each other in the core mold and configured to cut off the molten resin at an interface between the gate and the cavity; and

a receiving pin supported to be movable in the direction in which the cavity mold and the core mold are moved toward and away from each other in the cavity mold and having a central axis corresponding to a central axis of the cutting pin.

In this molding apparatus, the cutting pin cuts off the molten resin at the interface between the gate and the cavity when the molded hole is formed by cutting off the compressed part of the molten resin.

Thus, it is unnecessary to perform a post-step of cutting off the molded product from the molten resin filled and cured in the gate. As a result, the molding operation of the molded product can be performed with higher operating efficiency and within a shorter operating time period.

The molding apparatus according to a tenth embodiment of the present disclosure further includes:

a cutting pin supported to be movable in the direction in which the cavity mold and the core mold are moved toward and away from each other in the core mold and configured to cut off the molten resin at an interface between the gate and the cavity; and

a receiving pin supported to be movable in the direction in which the cavity mold and the core mold are moved toward and away from each other in the cavity mold and having a central axis corresponding to a central axis of the cutting pin.

In this molding apparatus, the first slider is provided with a cutting-pin cam portion engaged to be slidable with respect to the cutting pin so that the cutting pin is moved.

Further, in this molding apparatus, the second slider is provided with a receiving-pin cam portion engaged to be slidable with respect to the receiving pin so that the receiving pin is moved.

Still further, in this molding apparatus, the core pin and the cutting pin are configured to be movable simultaneously with each other in accordance with movement of the first slider.

Yet further, in this molding apparatus, the cavity pin and the receiving pin are configured to be movable simultaneously with each other in accordance with movement of the second slider.

Yet further, in this molding apparatus, the cutting pin cuts off the molten resin at the interface between the gate and the cavity when the molded hole is formed by cutting off the compressed part of the molten resin.

In other words, two sliders of the first slider and the second slider move four pins of the core pin, the cutting pin, the cavity pin, and the receiving pin. Thus, the mechanism can be simplified, and hence manufacturing cost can be reduced. In addition, the molding operation of the molded product can be performed with higher operating efficiency and within a shorter operating time period.

In the molding apparatus according to an eleventh embodiment of the present disclosure, the part of the molten resin, which has been compressed and cut off, is formed as a cut-off piece, the cut-off piece being configured to be inserted in the molded hole by moving the core pin and the cavity pin and to be held in the molded hole.

With this, it is unnecessary for the cavity pin or the core pin to be provided with a part configured to hold the cut-off piece. Thus, the shape of the cavity pin or the core pin is simplified, and hence the cavity pin or the core pin can be easily processed.

In the molding apparatus according to a twelfth embodiment of the present disclosure, the cut-off piece held in the molded hole is configured to be taken out from the cavity together with the molded product.

Thus, the molded product and the cut-off piece are taken out from the cavity in a single step, with the result that the molded product can be manufactured in a shorter time period.

The molding apparatus according to a thirteenth embodiment of the present disclosure further includes a fixing sleeve formed into a cylindrical shape extending in the direction in which the cavity mold and the core mold are moved toward and away from each other, and having one axial end portion provided with an inclined surface forming portion which is inclined with respect to the direction in which the cavity mold and the core mold are moved toward and away from each other and which is configured to form an inclined surface with respect to the molded product.

In this molding apparatus, the fixing sleeve is fixed in one of the core mold and the cavity mold under a state in which the inclined surface forming portion is positioned in the cavity.

Further, in this molding apparatus, one of the core pin and the cavity pin is supported to be slidable with respect to the fixing sleeve under a state of being inserted in the fixing sleeve.

Thus, the inclined surface can be easily formed with respect to the molded product. In addition, the inclined surface can be formed with respect to the molded product with a high degree of freedom in size.

Another molding apparatus according to a fourteenth embodiment of the present disclosure includes:

a cavity mold fixed at a predetermined position;

a core mold configured to be fitted against and clamped to the cavity mold so that a cavity in which molten resin is to be filled through a gate is formed;

a core pin supported to be movable in a direction in which the cavity mold and the core mold are moved toward and away from each other in the core mold and configured to form a resin compressed portion by compressing a part of the molten resin that has been filled in the cavity;

a cavity pin supported to be movable in the direction in which the cavity mold and the core mold are moved toward and away from each other in the cavity mold, having a central axis corresponding to a central axis of the core pin, and configured to form the resin compressed portion together with the core pin; and

a punch configured to be movable in the direction in which the cavity mold and the core mold are moved toward and away from each other and to form a molded hole in a molded product by cutting off the resin compressed portion.

In this molding apparatus, after the molten resin has been filled in the cavity, at least one of the core pin and the cavity pin is moved to be pressed onto the molten resin so that the part of the molten resin is compressed to be formed as the resin compressed portion before the molten resin is cured, and

the molded hole is formed by cutting off the resin compressed portion by the punch.

Thus, the molded hole is formed after the molten resin has been filled in the cavity, and hence it is unnecessary to use a large-scale heating apparatus or the like configured to perform rapid heating so as to prevent generation of weld lines. Thus, generation of weld lines is prevented without involving high manufacturing cost.

The molding apparatus according to a fifteenth embodiment of the present disclosure further includes a slider which includes a cam portion engaged to be slidable with respect to the at least one of the core pin and the cavity pin so that the at least one of the core pin and the cavity pin is moved and which is supported to be movable in a predetermined direction in the at least one of the core pin and the cavity pin.

In this way, the at least one of the core pin and the cavity pin can be reliably moved with a simple mechanism. As a result, a mechanism of the other molding apparatus can be simplified and manufacturing cost can be reduced.

The molding apparatus according to a sixteenth embodiment of the present disclosure further includes an urging spring configured to urge the at least one of the core pin and the cavity pin in a direction in which the at least one of the core pin and the cavity pin comes into contact with the cam portion of the slider.

With this, a high positional accuracy of the at least one of the core pin and the cavity pin respectively with respect to the core mold and the cavity mold can be secured. As a result, the at least one of the core pin and the cavity pin can be operated with higher reliability during the molding operation of the molded product.

A method of forming a molded product according to a seventeenth embodiment of the present disclosure includes:

forming a cavity with a cavity mold fixed at a predetermined position and a core mold configured to be fitted against and clamped to the cavity mold;

filling molten resin through a gate into the cavity;

compressing a part of the molten resin by pressing at least one of a core pin and a cavity pin onto the molten resin before the molten resin is cured, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the compressed part of the molten resin by moving the core pin and the cavity pin.

Thus, the molded hole is formed after the molten resin has been filled in the cavity, and hence it is unnecessary to use a large-scale heating apparatus or the like configured to perform rapid heating so as to prevent generation of weld lines. Thus, generation of weld lines is prevented without involving high manufacturing cost.

A molded product according to an eighteenth embodiment of the present disclosure is obtained by:

compressing a part of molten resin by pressing at least one of a core pin and a cavity pin onto the molten resin before the molten resin is cured, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the compressed part of the molten resin by moving the core pin and the cavity pin.

Thus, the molded hole is formed after the molten resin has been filled in the cavity, and hence it is unnecessary to use a large-scale heating apparatus or the like configured to perform rapid heating so as to prevent generation of weld lines. Thus, generation of weld lines is prevented without involving high manufacturing cost.

Another method of forming a molded product according to a nineteenth embodiment of the present disclosure includes:

forming a cavity with a cavity mold fixed at a predetermined position and a core mold configured to be fitted against and clamped to the cavity mold;

filling molten resin through a gate into the cavity;

pressing at least one of a core pin and a cavity pin onto the molten resin before the molten resin is cured so that a part of the molten resin is compressed to be formed as a resin compressed portion, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole in a molded product by cutting off the resin compressed portion by a punch.

Thus, the molded hole is formed after the molten resin has been filled in the cavity, and hence it is unnecessary to use a large-scale heating apparatus or the like configured to perform rapid heating so as to prevent generation of weld lines. Thus, generation of weld lines is prevented without involving high manufacturing cost.

Another molded product according to a twentieth embodiment of the present disclosure is obtained by:

pressing at least one of a core pin and a cavity pin onto molten resin before the molten resin is cured so that a part of the molten resin is compressed to be formed as a resin compressed portion, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the resin compressed portion by a punch.

Thus, the molded hole is formed after the molten resin has been filled in the cavity, and hence it is unnecessary to use a large-scale heating apparatus or the like configured to perform rapid heating so as to prevent generation of weld lines. Thus, generation of weld lines is prevented without involving high manufacturing cost.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a sectional view of a molding apparatus, illustrating an embodiment of the present disclosure together with FIGS. 2 to 43;

FIG. 2 is an enlarged sectional view of a part of the molding apparatus;

FIG. 3 is a sectional view illustrating an operation of the molding apparatus together with FIGS. 4 to 12, specifically, illustrating a state in which a core mold and a cavity mold have not been clamped to each other;

FIG. 4 is a sectional view illustrating a state in which the core mold and the cavity mold have been clamped to each other and molten resin has been filled in a cavity;

FIG. 5 is an enlarged sectional view illustrating positions of a core pin and a cavity pin under the state in which the molten resin has been filled in the cavity;

FIG. 6 is a sectional view illustrating a state in which a first slider has been moved;

FIG. 7 is an enlarged sectional view illustrating a state in which a part of the molten resin has been compressed by moving the core pin;

FIG. 8 is a sectional view illustrating a state in which the first slider has been further moved and a second slider also has been moved;

FIG. 9 is an enlarged sectional view illustrating a state in which the part of the molten resin has been cut off by further moving the core pin and moving the cavity pin in accordance therewith;

FIG. 10 is a sectional view illustrating a state in which the core mold and the cavity mold have been separated from each other;

FIG. 11 is an enlarged sectional view illustrating the state in which the core mold and the cavity mold have been separated from each other;

FIG. 12 is an enlarged perspective view of a molded body;

FIG. 13 is an enlarged sectional view illustrating, together with FIG. 14, an operation at the time when a cut-off piece is held in a molded hole, specifically, illustrating a state in which the cut-off piece has been inserted in the molded hole by moving the core pin and the cavity pin;

FIG. 14 is an enlarged sectional view illustrating a state in which the cut-off piece has been held in the molded hole after the core pin and the cavity pin have been moved;

FIG. 15 is an enlarged sectional view illustrating, together with FIGS. 16 and 17, an operation at the time when the cut-off piece is held in the molded hole after the part of the molten resin has been compressed by moving the cavity pin, specifically, illustrating a state in which the cut-off piece has been formed by moving the core pin and the cavity pin;

FIG. 16 is an enlarged sectional view illustrating a state in which the cut-off piece has been inserted in the molded hole by moving the core pin and the cavity pin;

FIG. 17 is an enlarged sectional view illustrating a state in which the cut-off piece has been held in the molded hole after the core pin and the cavity pin have been moved;

FIG. 18 is an enlarged sectional view illustrating, together with FIGS. 19 and 20, an operation in a case of using a fixing sleeve, specifically, illustrating a state in which the core pin and the cavity pin have not been moved;

FIG. 19 is an enlarged sectional view illustrating a state in which the part of the molten resin has been compressed by moving the core pin;

FIG. 20 is an enlarged sectional view illustrating a state in which the cut-off piece has been formed by moving the core pin and the cavity pin;

FIG. 21 is a sectional view illustrating a molding apparatus according to a first modification together with FIGS. 22 to 26;

FIG. 22 is an enlarged sectional view illustrating an operation of the molding apparatus according to the first modification together with FIGS. 23 to 26, specifically, illustrating a state in which the core mold and the cavity mold have not been clamped to each other;

FIG. 23 is an enlarged sectional view illustrating a state in which the core mold and the cavity mold have been clamped to each other and molten resin has been filled in the cavity;

FIG. 24 is an enlarged sectional view illustrating a state in which parts of the molten resin have been compressed by moving the first slider and moving the core pin and a cutting pin in accordance therewith;

FIG. 25 is an enlarged sectional view illustrating a state in which the parts of the molten resin have been cut off in the following manner: further moving the first slider; moving also the second slider; further moving the core pin and the cutting pin; and moving the cavity pin and a receiving pin;

FIG. 26 is a sectional view illustrating a state in which the core mold and the cavity mold have been separated from each other;

FIG. 27 is a sectional view illustrating a molding apparatus according to a second modification together with FIGS. 28 to 43;

FIG. 28 is an enlarged sectional view illustrating an operation of the molding apparatus according to the second modification together with FIGS. 29 to 39, specifically, illustrating a state in which the core mold and the cavity mold have not been clamped to each other;

FIG. 29 is a sectional view illustrating a state in which the core mold and the cavity mold have been clamped to each other and molten resin has been filled in the cavity;

FIG. 30 is an enlarged sectional view illustrating positions of the core pin and the cavity pin under the state in which the molten resin has been filled in the cavity;

FIG. 31 is a sectional view illustrating a state in which the second slider has been moved;

FIG. 32 is an enlarged sectional view illustrating a state in which a part of the molten resin has been compressed by moving the cavity pin;

FIG. 33 is a sectional view illustrating a state in which the cavity pin has been moved to return to an original position;

FIG. 34 is an enlarged sectional view illustrating the state in which the cavity pin has been moved to return to the original position;

FIG. 35 is a sectional view illustrating a state in which the core mold and the cavity mold have been separated from each other;

FIG. 36 is an enlarged sectional view illustrating the state in which the core mold and the cavity mold have been separated from each other;

FIG. 37 is an enlarged perspective view of the molded body;

FIG. 38 is an enlarged sectional view illustrating a state in which the molded body has been set to a receiving table of a cutting apparatus;

FIG. 39 is an enlarged sectional view illustrating a state in which a molded product has been formed by cutting off a resin compressed portion with a punch;

FIG. 40 is an enlarged sectional view illustrating, together with FIGS. 41 to 43, an example of forming a chamfered surface along an inner rim of the molded hole, specifically, illustrating positions of the core pin and the cavity pin under the state in which the molten resin has been filled in the cavity;

FIG. 41 is an enlarged sectional view illustrating a state in which the part of the molten resin has been compressed by moving the core pin;

FIG. 42 is an enlarged sectional view illustrating a state in which the molded body has been taken out by separating the core pin and the cavity pin from each other; and

FIG. 43 is an enlarged sectional view illustrating a state in which the molded product has been formed by cutting off the resin compressed portion by the punch.

### DETAILED DESCRIPTION OF EMBODIMENT

Hereinafter, an embodiment of the present disclosure will be described with reference to the drawings.

In the following description, vertical, horizontal, and depth directions are defined on a premise that a direction in which a fixed mold (cavity mold) and a movable mold (core mold) of an injection-molding mold assembly are moved toward and away from each other is the vertical direction.

Note that, the vertical, horizontal, and depth directions in the following description are indicated merely for the sake of convenience in description. Thus, the application of the present disclosure is not limited to those directions.

### (Structure of Molding Apparatus)

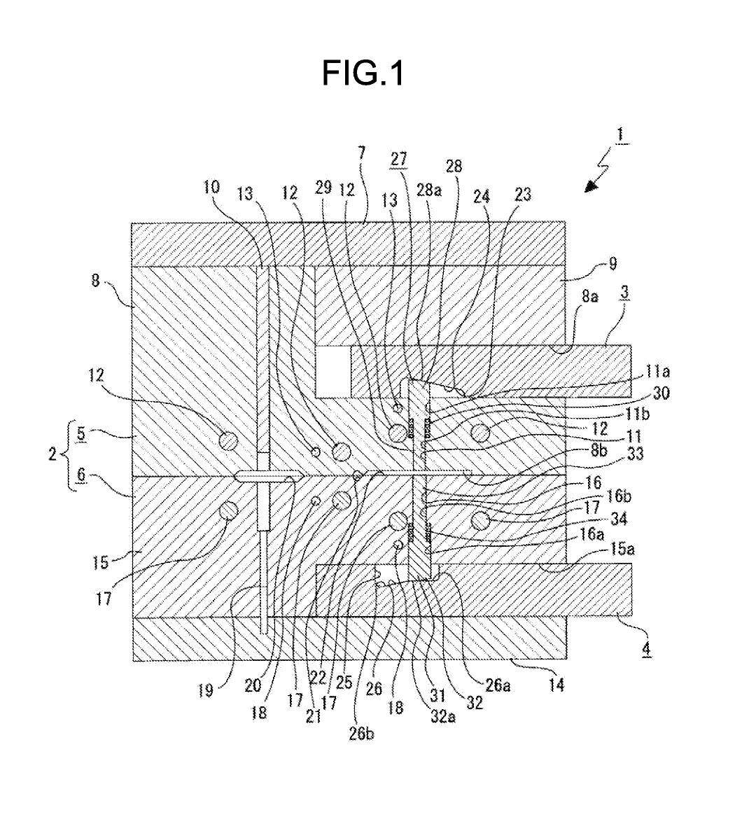

A molding apparatus 1 includes an injection-molding mold assembly 2, a first slider 3, and a second slider 4 (refer to FIG. 1).

The injection-molding mold assembly 2 is formed of a core mold 5 and a cavity mold 6 that can be moved toward and away from each other in the vertical direction. The core mold 5 is a movable mold to be moved upward and downward above the cavity mold 6, and the cavity mold 6 is a fixed mold.

The core mold 5 includes a base portion 7, a molding portion 8 fixed to a lower surface of the base portion 7, a fixed portion 9 fixed to the lower surface of the base portion 7, and an insertion portion 10 inserted and fixed in a vertically extending hole formed through the molding portion 8.

One side portion of the molding portion 8 is provided with a sliding recessed portion 8a opened sidewise on a lower side of the fixed portion 9.

A pin support hole 11 is formed to vertically pass through the molding portion 8, and the pin support hole 11 is formed of a large diameter portion 11a positioned on an upper side and a small diameter portion 11b positioned on a lower side of the large diameter portion 11a. An upper opening of the pin support hole 11 is communicated to the sliding recessed portion 8a.

The molding portion 8 is provided with a plurality of holes and recessed portions to form a sprue, a runner, or a gate described below.

The molding portion 8 is embedded with heaters 12, 12, . . . , and temperature controllers 13 and 13. Each of the temperature controllers 13 and 13 has a function to monitor temperatures of the heaters 12, 12, . . . so as to control a temperature of the core mold 5.

The molding portion 8 is provided with a shallow filling recessed portion 8b opened downward. The filling recessed portion 8b is communicated with a lower opening of the pin support hole 11.

In the core mold 5, an ejector pin (not shown) is supported to be movable in the vertical direction.

The cavity mold 6 includes a base portion 14 and a molding portion 15 fixed to an upper surface of the base portion 14.

A lower end portion of the molding portion 15 is provided with a sliding recessed portion 15a opened sidewise on an upper side of the base portion 14.

A pin support hole 16 is formed to vertically pass through the molding portion 15, and the pin support hole 16 is formed of a large diameter portion 16a positioned on a lower side and a small diameter portion 16b positioned on an upper side of the large diameter portion 16a. A lower opening of the pin support hole 16 is communicated to the sliding recessed portion 15a. The pin support hole 16 is positioned directly below the pin support hole 11 formed in the core mold 5.

The molding portion 15 is provided with a plurality of holes and recessed portions to form the sprue, the runner, or the gate.

The molding portion 15 is embedded with heaters 17, 17, . . . , and temperature controllers 18 and 18. Each of the temperature controllers 18 and 18 has a function to monitor temperatures of the heaters 17, 17, . . . so as to control a temperature of the cavity mold 6.

When the core mold 5 positioned on the cavity mold 6 is moved downward so that the core mold 5 is fitted against and clamped to the cavity mold 6, a sprue 19, a runner 20, and a gate 21 are formed in the injection-molding mold assembly 2. A cavity 22 is formed by the filling recessed portion 8b of the core mold 5 and an upper surface of the molding portion 15 of the cavity mold 6. The runner 20 is formed into a curved shape. When the runner 20 is formed into the curved shape, a flow rate of molten resin (described below) to be filled in the cavity 22 is reduced. With this, flow marks (flow patterns) liable to be generated owing to high flow rate are prevented from being generated on a molded product.

The first slider 3 is supported in the sliding recessed portion 8a of the core mold 5 so as to be movable in the horizontal direction. The first slider 3 is coupled, for example, to a piston supported by a cylinder (not shown), and is moved in the horizontal direction by actuating the piston with a drive force of a motor (not shown).

The first slider 3 is provided with a core-pin cam portion 23 opened downward. A surface positioned on an upper side of the core-pin cam portion 23 is formed as a cam surface 24 inclined in a manner of being displaced downward toward the right.

The second slider 4 is supported in the sliding recessed portion 15a of the cavity mold 6 so as to be movable in the horizontal direction. The second slider 4 is coupled, for example, to a piston supported by a cylinder (not shown), and is moved in the horizontal direction by actuating the piston with a drive force of a motor (not shown).

The second slider 4 is provided with a cavity-pin cam portion 25 opened upward. A surface positioned on a lower side of the cavity-pin cam portion 25 is formed as a cam surface 26, and the cam surface 26 is formed of an inoperative portion 26a directed upward and an operative portion 26b inclined in a manner of being displaced downward toward the left.

In the pin support hole 11 of the core mold 5, a core pin 27 is supported to be movable in the vertical direction. The core pin 27 is formed of a large diameter shaft portion 28 positioned on the upper side and a small diameter shaft portion 29 positioned on the lower side and having an outer diameter smaller than that of the large diameter shaft portion 28. An upper end portion of the large diameter shaft portion 28 is inserted in the core-pin cam portion 23 of the first slider 3.

An upper surface of the large diameter shaft portion 28 is formed as a cam sliding surface 28a to be subjected to sliding of the cam surface 24 of the core-pin cam portion 23.

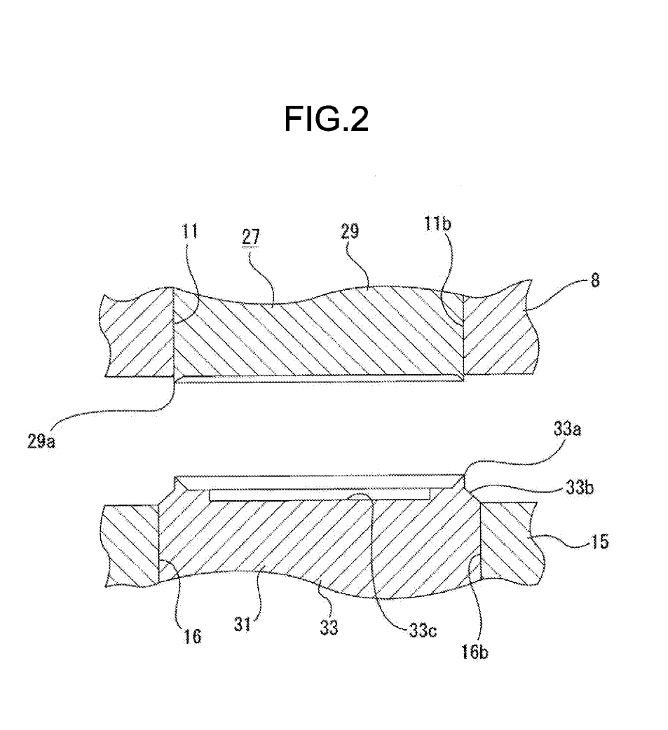

A cutting edge 29a projected downward is formed along an outer peripheral portion of a lower end portion of the small diameter shaft portion 29 (refer to FIG. 2).

A first urging spring 30 is arranged in the large diameter portion 11a of the pin support hole 11 (refer to FIG. 1), and, for example, a compression coil spring is used as the first urging spring 30. The first urging spring 30 is arranged in a compressed state between an upward stepped surface 11c formed between the large diameter portion 11a and the small diameter portion 11b of the pin support hole 11 and a downward stepped surface 27a formed between the large diameter shaft portion 28 and the small diameter shaft portion of the core pin 27. Thus, the first urging spring 30 applies an upward urging force to the core pin 27, and the cam sliding surface 28a of the core pin 27 is pressed onto the cam surface 24 of the core-pin cam portion 23.

In the pin support hole 16 of the cavity mold 6, a cavity pin 31 is supported to be movable in the vertical direction. A central axis of the cavity pin 31 corresponds to a central axis of the core pin 27. The cavity pin 31 is formed of a large diameter shaft portion 32 positioned on the lower side and a small diameter shaft portion 33 positioned on the upper side and having an outer diameter smaller than that of the large diameter shaft portion 32. A lower end portion of the large diameter shaft portion 32 is inserted in the cavity-pin cam portion 25 of the second slider 4.

A lower surface of the large diameter shaft portion 32 is formed as a cam sliding surface 32a to be subjected to sliding of the cam surface 26 of the cavity-pin cam portion 25.

A cutting portion 33a projected upward is formed along an outer peripheral portion of an upper end portion of the small diameter shaft portion 33 (refer to FIG. 2). The cutting portion 33a is positioned directly below the cutting edge 29a provided to the core pin 27.

An outer part of the cutting portion 33a of the small diameter shaft portion 33 is formed as a surface forming portion 33b inclined in a manner of being displaced downward toward an outer periphery. The surface forming portion 33b is a part configured to form a chamfered surface (inclined surface) 201a with respect to a molded product (described below) to be formed by the injection-molding mold assembly 2.

In an upper surface of the small diameter shaft portion 33, a holding recessed portion 33c opened upward is formed at a part except the outer peripheral portion.

A second urging spring 34 is arranged in the large diameter portion 16a of the pin support hole 16 (refer to FIG. 1), and, for example, a compression coil spring is used as the second urging spring 34. The second urging spring 34 is arranged in a compressed state between a downward stepped surface 16c formed between the large diameter portion 16a and the small diameter portion 16b of the pin support hole 16 and an upward stepped surface 31a formed between the large diameter shaft portion 32 and the small diameter shaft portion 33 of the cavity pin 31. Thus, the second urging spring 34 applies a downward urging force to the cavity pin 31, and the cam sliding surface 32a of the cavity pin 31 is pressed onto the cam surface 26 of the cavity-pin cam portion 25.

### (Operation of Molding Apparatus)

In the following, description is made of an operation of the molding apparatus 1 (refer to FIGS. 2 to 11).

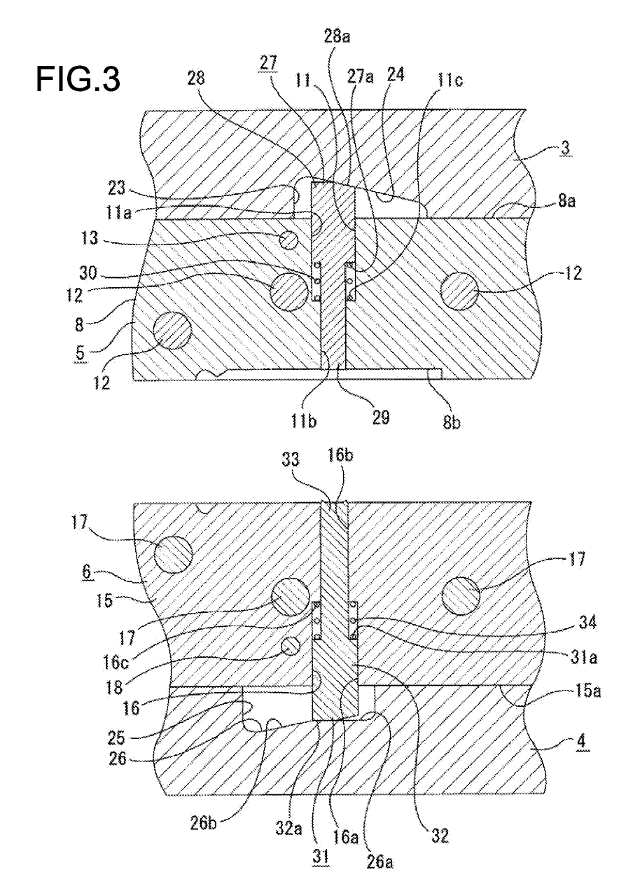

First, description is made of the portions in an initial state in which molten resin 100 has not been filled in the cavity 22 (refer to FIGS. 2 and 3).

In the initial state, the first slider 3 is held at a right moving end, and the core pin 27 is held at an upper moving end (refer to FIG. 3). At this time, the cutting edge 29a of the core pin 27 is projected downward with respect to the pin support hole 11 (refer to FIG. 2).

In the initial state, the second slider 4 is held at a left moving end, and the cavity pin 31 is held at an upper moving end (refer to FIG. 3). At this time, the cam sliding surface 32a of the cavity pin 31 is in a state of being held in contact with the inoperative portion 26a of the cam surface 26 of the cavity-pin cam portion 25, and the cutting portion 33a and the surface forming portion 33b is projected upward with respect to the pin support hole 16 (refer to FIG. 2).

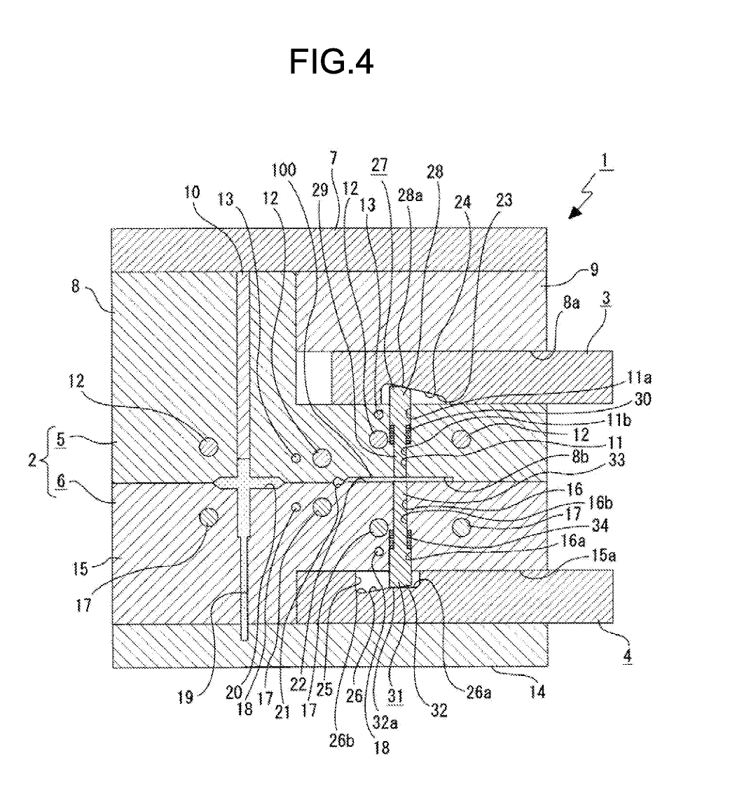

In the initial state, when the core mold 5 is moved downward so that the core mold 5 is fitted against and clamped to the cavity mold 6, the sprue 19, the runner 20, and the gate 21, and the cavity 22 are formed as described above (refer to FIG. 4).

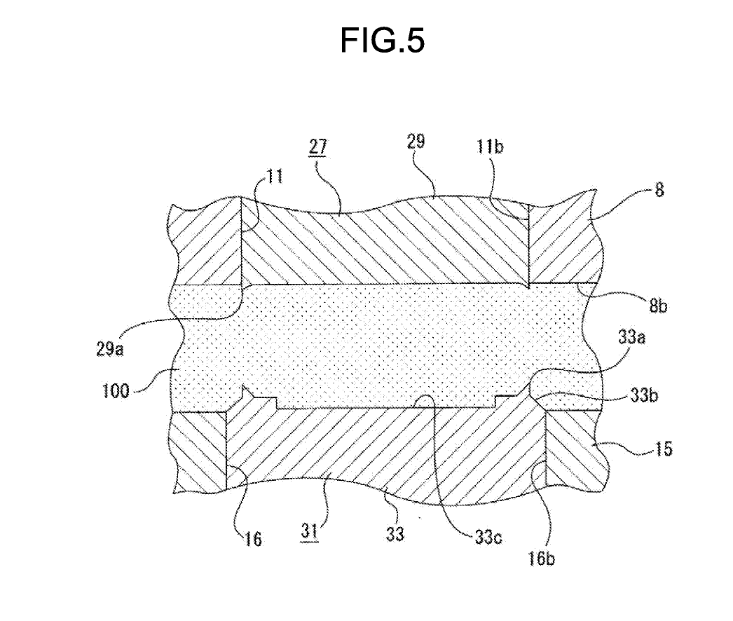

After the core mold 5 has been fitted against and clamped to the cavity mold 6 so that the sprue 19, the runner 20, and the gate 21, and the cavity 22 are formed, the molten resin 100 is filled from a resin storage tank (not shown) through the sprue 19, the runner 20, and the gate 21 into the cavity 22 (refer to FIGS. 4 and 5). At this time, the heaters 12, 12, . . . , and 17, 17, . . . are energized, and the temperature controllers 13, 13, 18, and 18 respectively monitor the temperatures of the heaters 12, 12, . . . and 17, 17, . . . so as to control the temperatures of the core mold 5 and the cavity mold 6.

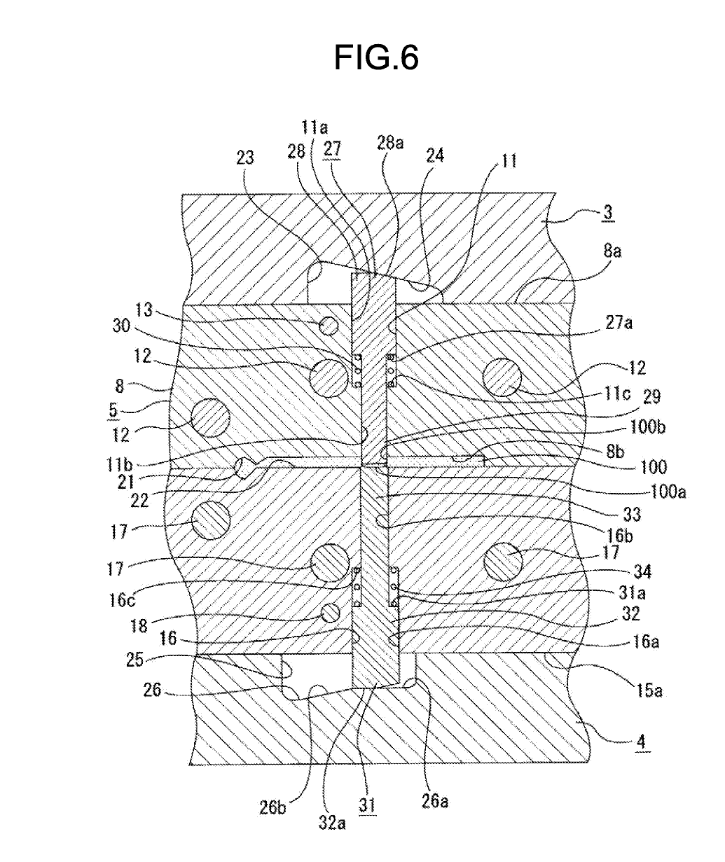

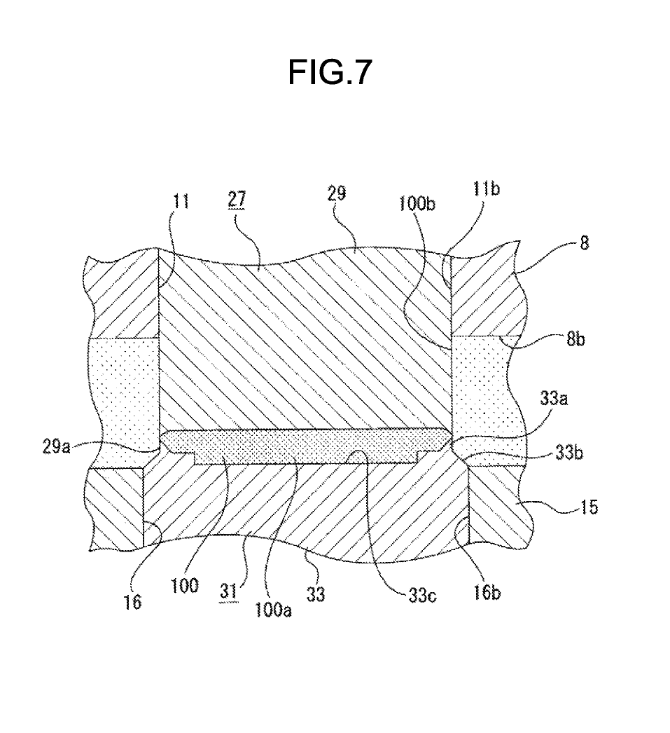

After the molten resin 100 has been filled in the cavity 22, the first slider 3 is moved to the left and stopped at a predetermined position before the molten resin 100 is cured (refer to FIG. 6). When the first slider 3 is moved to the left, the cam surface 24 is slid against the cam sliding surface 28a of the core pin 27, and in accordance therewith, the core pin 27 is moved downward (refer to FIG. 7). In this way, a part 100a of the molten resin 100 is compressed to form a molded recessed portion 100b opened upward in the molten resin 100.

The core pin 27 that has been moved downward is stopped at a position at which the cutting edge 29a of the core pin 27 has come close to the cutting portion 33a of the cavity pin 31.

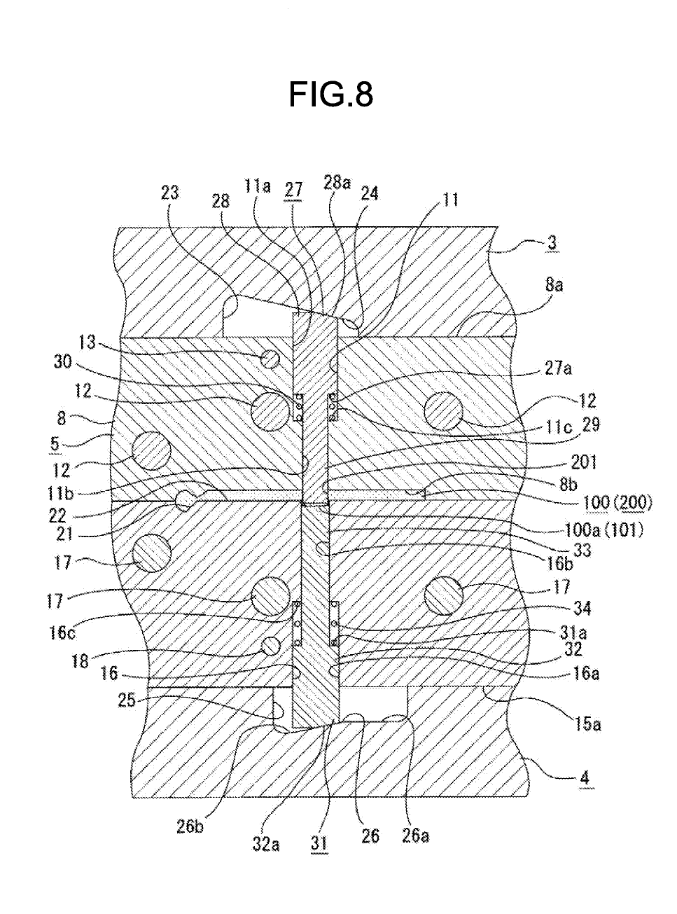

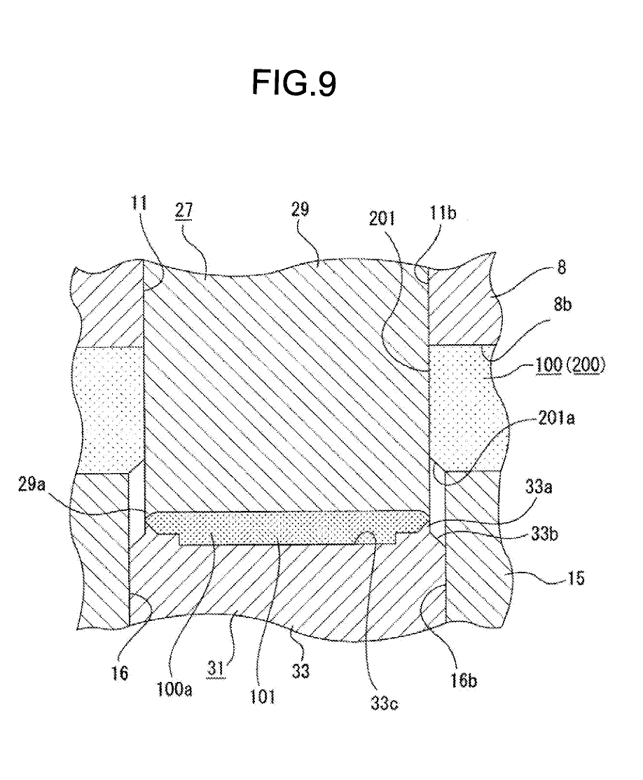

Next, under a state in which curing of the molten resin 100 has proceeded, specifically, under a state immediately before the molten resin 100 is cured, the first slider 3 is moved to the left again, and the second slider 4 is moved to the right (refer to FIG. 8). When the first slider 3 is moved to the left again, the cam surface 24 is slid against the cam sliding surface 28a of the core pin 27 in accordance therewith. As a result, the core pin 27 is moved further downward. When the second slider 4 is moved to the right, the inoperative portion 26a and the operative portion 26b of the cam surface 26 are sequentially slid against the cam sliding surface 32a of the cavity pin 31, and in accordance therewith, the cavity pin 31 is moved downward (refer to FIG. 9). In this way, the part 100a of the molten resin 100 is cut off to form a molded hole 201.

Note that, when the molten resin 100 is filled in the cavity 22, the heaters 12, 12, . . . , and 17, 17, . . . are energized as described above so as to suppress a cooling speed of the filled molten resin 100.

In this way, a time period until the molten resin 100 is cured can be prolonged. With this, the part 100a of the molten resin 100 can be compressed in an optimum state, that is, an uncured state. In addition, in this optimum state, that is, the uncured state, the molded hole 201 is formed by cutting off the part 100a of the molten resin 100. As a result, the molded hole 201 can be processed with higher accuracy.

The cut-off part of the molten resin 100 is held between the core pin 27 and the cavity pin 31, and is formed as a cut-off piece 101.

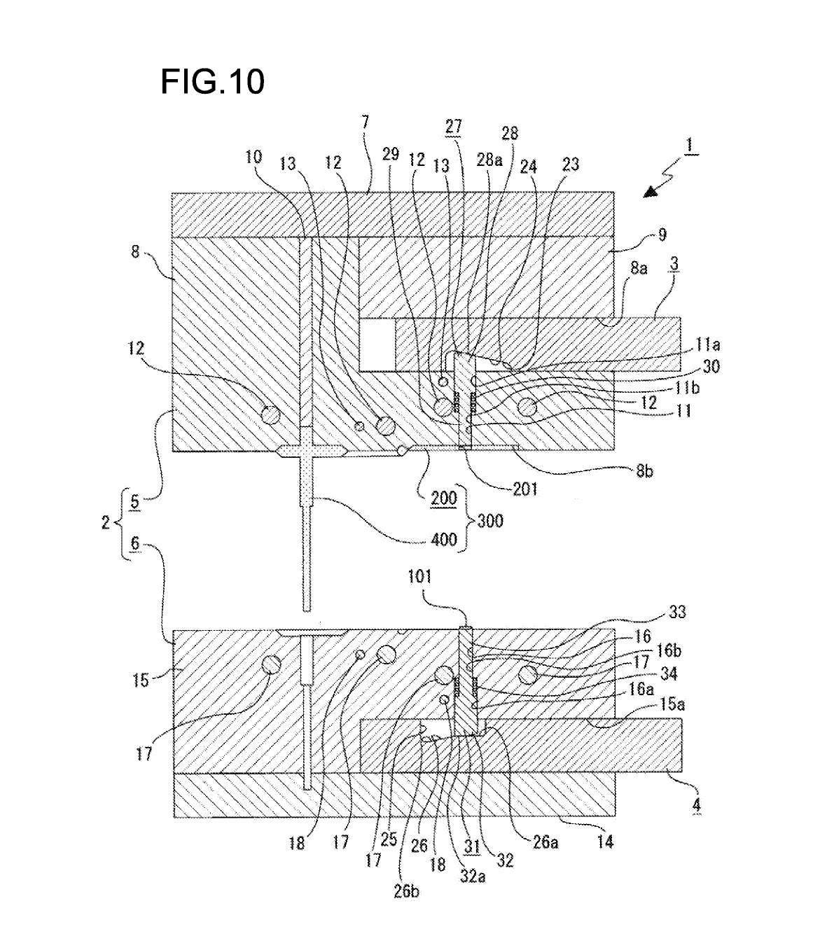

After the molten resin 100 has been cured, the core mold 5 is moved upward so that the core mold 5 and the cavity mold 6 are separated from each other. Then, the first slider 3 and the second slider 4 are moved to the positions in the initial state. In accordance therewith, the core pin 27 and the cavity pin 31 are moved upward to the positions in the initial state (refer to FIG. 10).

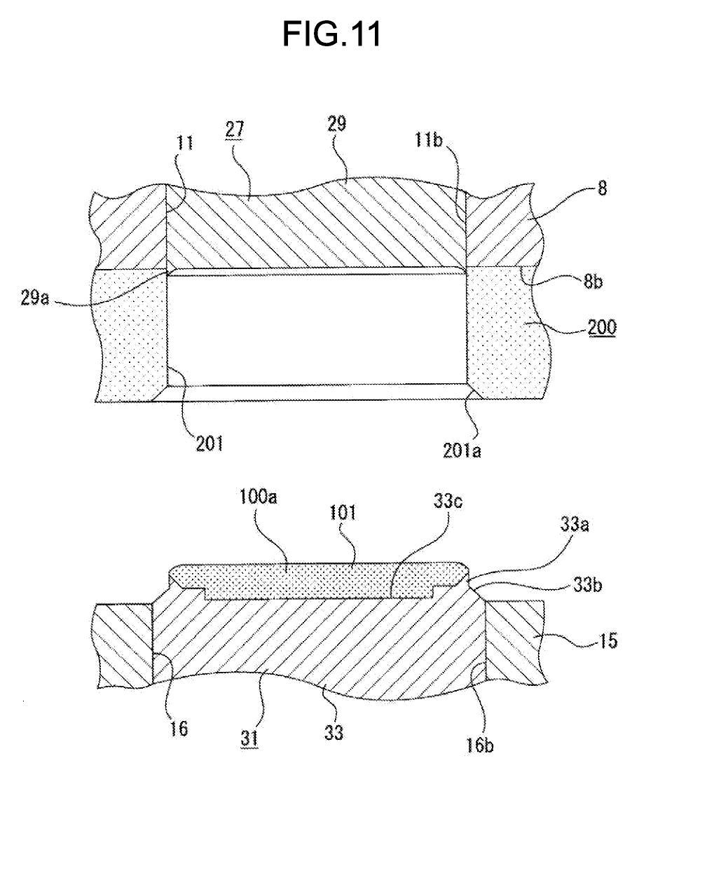

At this time, the filling recessed portion 8b that has been formed in the core mold 5 allows parts except the cut-off piece 101 of the molten resin 100 to adhere to the core mold 5. In addition, the holding recessed portion 33c that has been formed in the cavity pin 31 allows the cut-off piece 101 itself to adhere to the cavity pin 31 (refer to FIGS. 10 and 11).

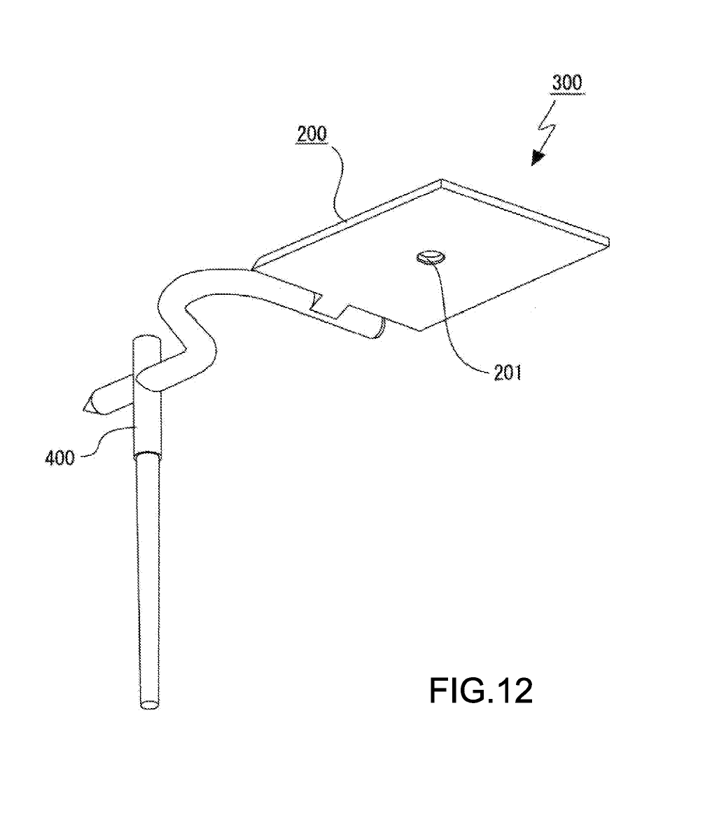

Under a state in which the core mold 5 and the cavity mold 6 have been separated from each other, the molten resin 100 has been cured and a molded body 300 has been formed. The molded body 300 is formed of an integral piece of a molded product 200 which is to be used as a product and provided with the molded hole 201, and a resin cured product 400 formed of the molten resin 100 that has remained and has been cured in the sprue 19, the runner 20, and the gate 21 (refer to FIGS. 10 and 12).

The molded body 300 is taken out from the core mold by being pushed out by the ejector pin supported in the core mold 5. After the molded body 300 has been taken out, the resin cured product 400 and the molded product 200 are cut off from each other with a cutter and the like. In this way, the molded product 200 is formed. The molded product 200 is provided with the molded hole 201, and the molded hole 201 is provided with the chamfered surface 201a formed by the surface forming portion 33b of the cavity pin 31 (refer to FIGS. 11 and 12).

Meanwhile, the cut-off piece 101 is taken out from the cavity pin 31 by being sucked by a sucker (not shown). At this time, suction pressure of the sucker has been measured by a measurer (not shown). When the measurer detects suction pressure equal to or more than a predetermined value, it is judged that the sucker has performed a sucking operation with respect to the cut-off piece 101. Based on this judgment result, the core mold 5 and the cavity mold 6 are clamped to each other.

Thus, when the measurer detects suction pressure less than a predetermined value, there is a high risk that the sucker has not properly performed the sucking operation with respect to the cavity pin 31. Thus, the core mold 5 and the cavity mold 6 are not clamped to each other.

As described above, in the molding apparatus 1, the core mold 5 and the cavity mold 6 are clamped to each other when a measured value of the suction pressure of the sucker configured to suck the cut-off piece 101 is equal to or more than a predetermined value. Thus, the core mold 5 and the cavity mold 6 are not clamped to each other as long as the cut-off piece 101 remains on the cavity pin 31. As a result, the cut-off piece 101 is prevented from being nipped between the core mold 5 and the cavity mold 6.

Further, in the molding apparatus 1, the core mold is provided with the filling recessed portion 8b, and the cavity pin 31 is provided with the holding recessed portion 33c configured to hold the cut-off piece 101. With this, after the core mold 5 and the cavity mold 6 have been separated from each other, the molded product 200 remains in the filling recessed portion 8b and adheres to the core mold 5, and the cut-off piece 101 remains in the holding recessed portion 33c and adheres to the cavity pin 31.

In this way, the molded product 200 (molded body 300) and the cut-off piece 101 are respectively taken out from the core mold 5 and the cavity pin 31 separate from each other. Thus, the molded product 200 and the cut-off piece 101 can be simultaneously taken out. As a result, a molding operation of the molded product 200 can be performed within a shorter operating time period.

Further, the molding apparatus 1 is provided with the first slider 3 including the core-pin cam portion 23 and the second slider 4 including the cavity-pin cam portion 25. By operating the first slider 3 and the second slider 4, the core pin 27 and the cavity pin 31 are respectively moved in necessary directions so that the molded hole 201 is formed in the molded product 200.

In this way, the core pin 27 and the cavity pin 31 can be reliably moved with a simple mechanism. As a result, the mechanism of the molding apparatus 1 can be simplified and manufacturing cost can be reduced.

Still further, the molding apparatus 1 is provided with the first urging spring 30 configured to urge the core pin 27 in a direction in which the core pin 27 comes into contact with the core-pin cam portion 23 of the first slider 3, and the second urging spring 34 configured to urge the cavity pin 31 in a direction in which the cavity pin 31 comes into contact with the cavity-pin cam portion 25 of the second slider 4.

With this, high positional accuracies of the core pin 27 and the cavity pin 31 respectively with respect to the core mold 5 and the cavity mold 6 can be secured. As a result, the core pin 27 and the cavity pin 31 can be operated with higher reliability during the molding operation of the molded product 200.

Note that, in the molding apparatus 1, the cutting edge 29a projected to the cavity pin 31 side is formed along the outer peripheral portion of a distal end portion of the core pin 27.

With this, when the molded hole 201 is formed in the molded product 200 by the cutting edge 29a, a condition of a cut surface is satisfactorily secured. As a result, the molded hole 201 can be processed with higher accuracy.

Further, the cutting portion 33a projected to the core pin 27 side is formed along the outer peripheral portion of a distal end portion of the cavity pin 31.

With this, when the molded hole 201 is formed in the molded product 200 by the cutting portion 33a, the condition of the cut surface is more satisfactorily secured. As a result, the molded hole 201 can be processed with much higher accuracy.

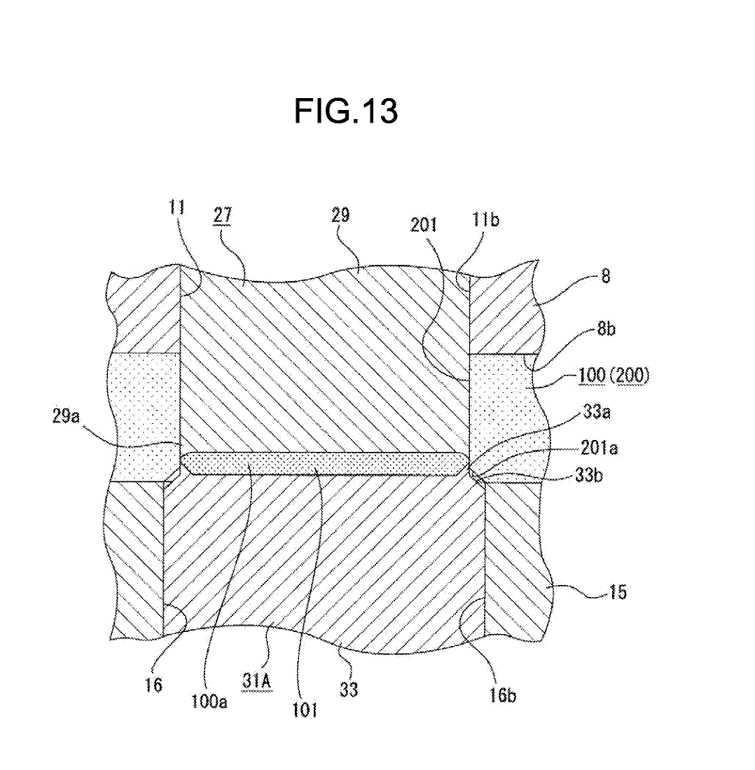

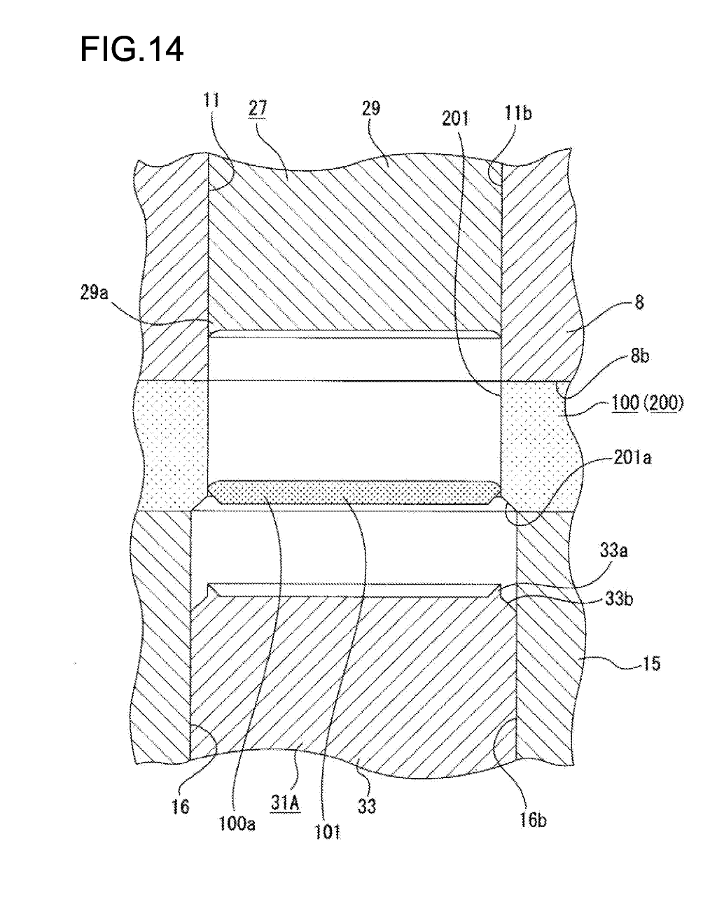

In the example illustrated hereinabove, the cut-off piece 101 adheres to the cavity pin 31 and is taken out from the cavity pin 31. Alternatively, as described below, the cut-off piece 101 may be taken out after being held in the molded hole 201 (refer to FIGS. 13 and 14).

Note that, a cavity pin 31A, which is used in a case where the cut-off piece 101 is held in the molded hole 201, is not provided with the holding recessed portion 33c configured to hold the cut-off piece 101.

As described above, after the core pin 27 and the cavity pin 31A have been moved downward so as to form the cut-off piece 101 (refer to FIG. 9), the core pin 27 and the cavity pin 31A are moved upward so as to insert the cut-off piece 101 in the molded hole 201 (refer to FIG. 13). At this time, an outer peripheral surface of the cut-off piece 101 is held in contact with a markedly small area of the molten resin 100, and the cut-off piece 101 is integrated with the molten resin 100.

Next, the core pin 27 is moved upward and the cavity pin 31A is moved downward in accordance therewith. In this way, the core pin 27 and the cavity pin 31A are separated vertically from the cut-off piece 101, with the result that the cut-off piece 101 is held in the molded hole 201 (refer to FIG. 14).

Subsequently, the core mold 5 is moved upward so that the core mold 5 and the cavity mold 6 are separated from each other, with the molten resin 100 adhering to the core mold 5 while holding the cut-off piece 101. In this way, the molten resin 100 is formed as the molded body 300. The molded body 300 is taken out from the core mold 5 by being pushed out by the ejector pin supported in the core mold 5. At this time, the cut-off piece 101 is taken out from the molded hole 201 by being pushed out, for example, by a take-out pin (not shown) supported in the core mold simultaneously with the molded body 300 to be taken out by the ejector pin. Alternatively, the cut-off piece 101 may be taken out from the molded hole 201 by being pressed, for example, with a take-out jig (not shown) after the molded body 300 has been taken out by the ejector pin.

As described above, when the cut-off piece 101 is configured to be inserted in the molded hole 201 by moving the core pin 27 and the cavity pin 31A and held in the molded hole 201, it is unnecessary for the cavity pin 31A or the core pin 27 to be provided with the holding recessed portion configured to hold the cut-off piece 101. Thus, the shape of the cavity pin 31A or the core pin 27 is simplified, and hence the cavity pin 31A or the core pin 27 can be easily processed.

Further, when the cut-off piece 101 held in the molded hole 201 is taken out from the cavity 22 together with the molded body 300, the cut-off piece 101 can be taken out from the molded hole 201 simultaneously with the molded body 300 to be taken out by the ejector pin. Thus, the molded body 300 and the cut-off piece 101 are taken out from the cavity 22 in a single step, with the result that the molded product 200 can be manufactured in a shorter time period.

Still further, when the cut-off piece 101 held in the molded hole 201 is taken out from the cavity 22 together with the molded body 300, the cut-off piece 101 can be taken out from the molded hole 201 also after the molded body 300 has been taken out by the ejector pin. Thus, it is no longer necessary to use the sucker, the take-out pin, and the like configured to take out the cut-off piece 101 from the molded body 300, and hence the cut-off piece 101 can be easily taken out at lower cost by using the take-out jig. In addition, the cut-off piece 101 is taken out from the molded hole 201 after the molded body 300 has been taken out from the injection-molding mold assembly 2, and hence the cut-off piece 101 is prevented from dropping to the inside of the injection-molding mold assembly 2.

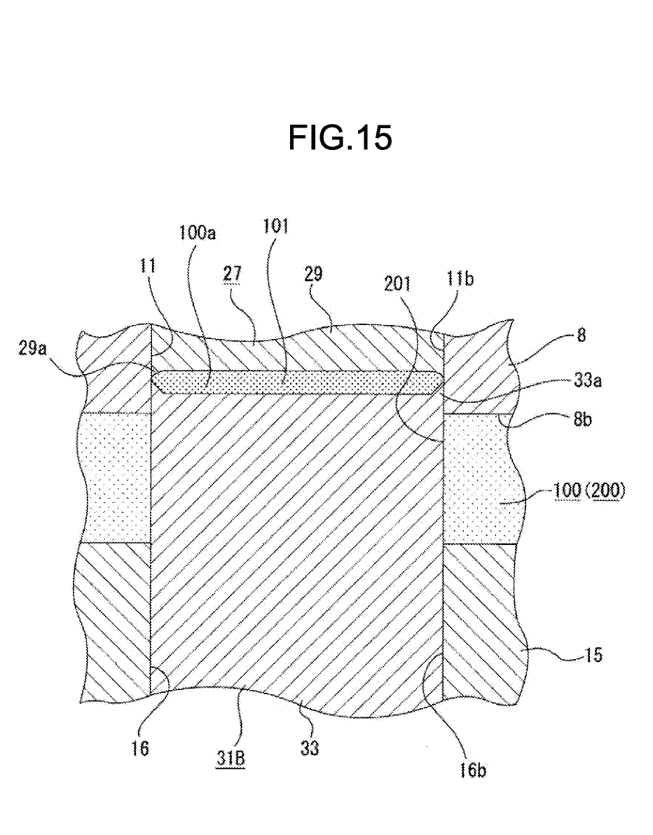

Note that, in the example illustrated hereinabove, the molded hole 201 is formed by compressing the part 100a of the molten resin 100 by moving the core pin 27 downward. However, reversely, as described below, the molded hole 201 may be formed by moving a cavity pin 31B upward so as to compress the part 100a of the molten resin 100 (refer to FIGS. 15 to 17).

The cavity pin 31B is not provided with the surface forming portion 33b configured to form the chamfered surface (inclined surface) 201a with respect to the molded product 200.

After the molten resin 100 has been filled in the cavity 22 (refer to FIG. 5), the cavity pin 31B is moved upward so as to compress the part 100a of the molten resin 100 before the molten resin 100 is cured. Next, the core pin 27 and the cavity pin 31B are moved upward so as to cut off the part 100a of the molten resin 100. In this way, the molded hole 201 is formed (refer to FIG. 15). The part 100a thus cut off from the molten resin 100 is formed as the cut-off piece 101.

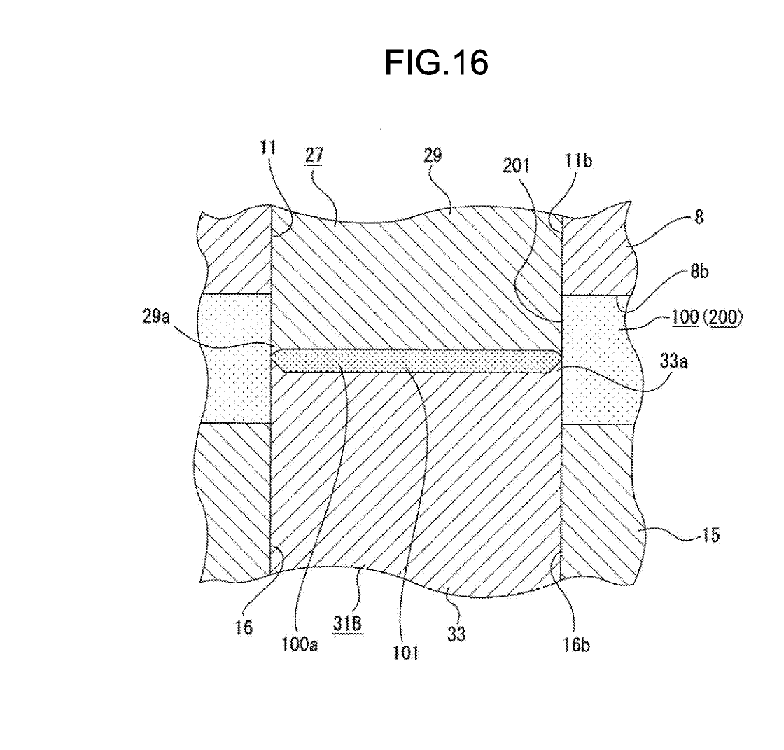

After that, the core pin 27 and the cavity pin 31B are moved downward so as to insert the cut-off piece 101 in the molded hole 201 (refer to FIG. 16). In this case, the outer peripheral surface of the cut-off piece 101 is held in contact with a markedly small area of the molten resin 100, and the cut-off piece 101 is integrated with the molten resin 100.

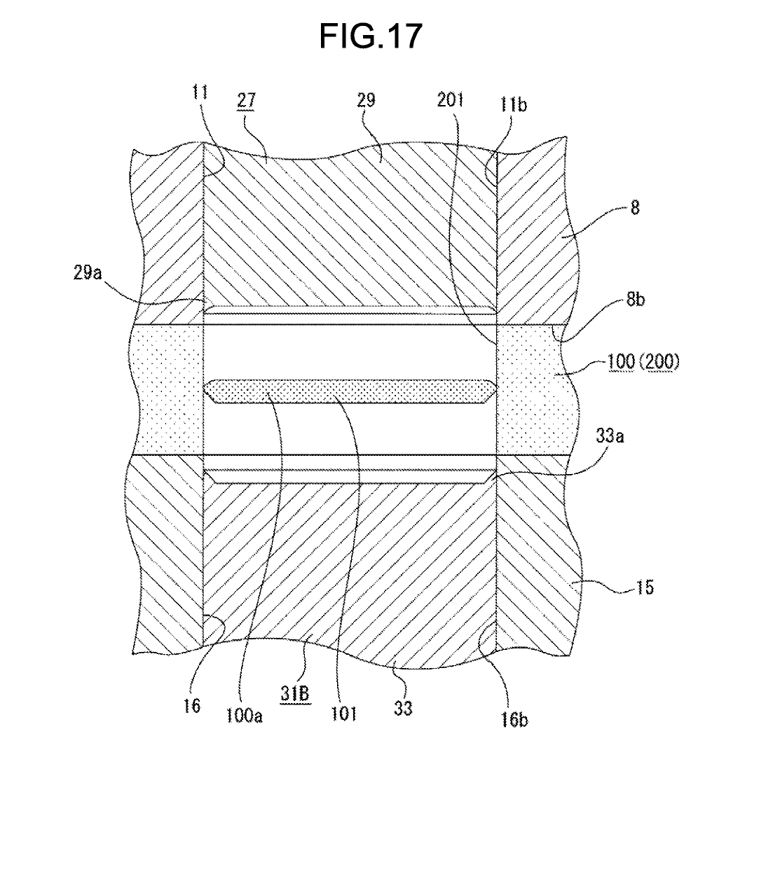

Next, the core pin 27 is moved upward and the cavity pin 31B is moved downward in accordance therewith. In this way, the core pin 27 and the cavity pin 31B are separated vertically from the cut-off piece 101, with the result that the cut-off piece 101 is held in the molded hole 201 (refer to FIG. 17).

Subsequently, the core mold 5 is moved upward so that the core mold 5 and the cavity mold 6 are separated from each other, with the molten resin 100 adhering to the core mold 5 while holding the cut-off piece 101. In this way, the molten resin 100 is formed as the molded body 300. The molded body 300 is taken out from the core mold 5 by being pushed out by the ejector pin supported in the core mold 5. At this time, the cut-off piece 101 is taken out from the molded hole 201 by being pushed out, for example, by the take-out pin (not shown) supported in the core mold simultaneously with the molded body 300 to be taken out by the ejector pin. Alternatively, the cut-off piece 101 may be taken out from the molded hole 201 by being pressed, for example, with the take-out jig (not shown) after the molded body 300 has been taken out by the ejector pin.

As described above, when the cut-off piece 101 is configured to be inserted in the molded hole 201 by moving the core pin 27 and the cavity pin 31B and held in the molded hole 201, it is unnecessary for the cavity pin 31B or the core pin 27 to be provided with the holding recessed portion configured to hold the cut-off piece 101. Thus, the shape of the cavity pin 31B or the core pin 27 is simplified, and hence the cavity pin 31B or the core pin 27 can be easily processed.

Further, when the cut-off piece 101 held in the molded hole 201 is taken out from the cavity 22 together with the molded body 300, the cut-off piece 101 can be taken out from the molded hole 201 simultaneously with the molded body 300 to be taken out by the ejector pin. Thus, the molded body 300 and the cut-off piece 101 are taken out from the cavity 22 in a single step, with the result that the molded product 200 can be manufactured in a shorter time period.

Still further, when the cut-off piece 101 held in the molded hole 201 is taken out from the cavity 22 together with the molded body 300, the cut-off piece 101 can be taken out from the molded hole 201 also after the molded body 300 has been taken out by the ejector pin. Thus, it is no longer necessary to use the sucker, the take-out pin, and the like configured to take out the cut-off piece 101 from the molded body 300, and hence the cut-off piece 101 can be easily taken out at lower cost by using the take-out jig. In addition, the cut-off piece 101 is taken out from the molded hole 201 after the molded body 300 has been taken out from the injection-molding mold assembly 2, and hence the cut-off piece 101 is prevented from dropping to the inside of the injection-molding mold assembly 2.

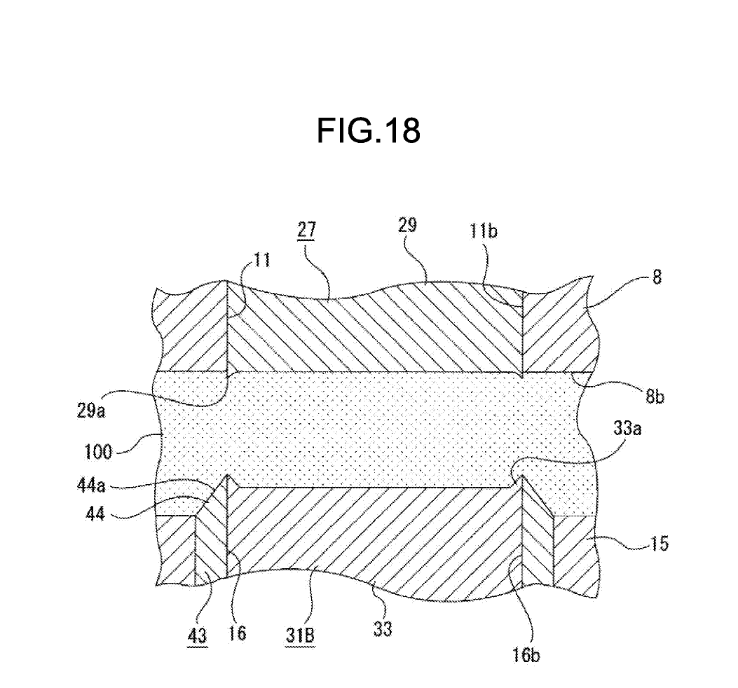

Further, the chamfered surface 201a can be formed with respect to the molded product 200 also by using a fixing sleeve 43 as described below (refer to FIGS. 18 to 20). Use of the fixing sleeve 43 is especially advantageous in forming the chamfered surface 201a having a large area.

The fixing sleeve 43 is formed into a substantially cylindrical shape, and is arranged in a manner of being fixed to the cavity mold 6, for example (refer to FIG. 18). An axial upper end portion of the fixing sleeve 43 is provided as an inclined surface forming portion 44, specifically, has an outer surface formed as a forming surface 44a inclined so as to be displaced downward outward.

The inclined surface forming portion 44 of the fixing sleeve 43 is positioned in the cavity 22.

The cavity pin 31B is inserted in the fixing sleeve 43 and supported to be slidable with respect to the fixing sleeve 43. In an initial state, the cavity pin 31B is positioned such that an upper end of the cavity pin 31B corresponds to an upper end of the fixing sleeve 43.

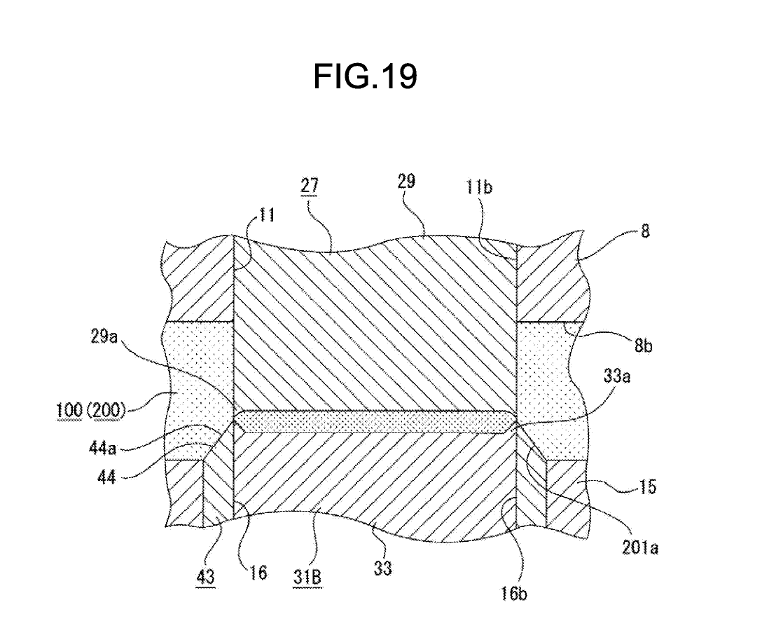

After the molten resin 100 has been filled in the cavity 22, the core pin 27 is moved downward before the molten resin 100 is cured. The core pin 27 is stopped at a position at which the cutting edge 29a of the core pin 27 has come close to the cutting portion 33a of the cavity pin 31B (refer to FIG. 19).

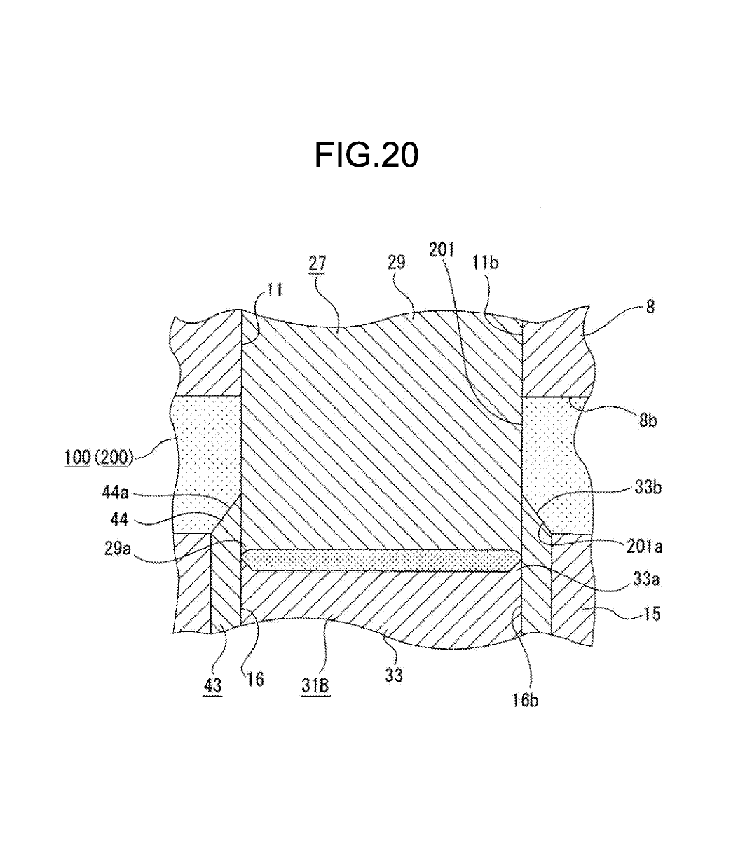

Next, under the state in which curing of the molten resin 100 has proceeded, specifically, under the state immediately before the molten resin 100 is cured, the core pin 27 and the cavity pin 31B are moved downward so as to cut off the part 100a of the molten resin 100. In this way, the molded hole 201 is formed (refer to FIG. 20).

Subsequently, the core mold 5 is moved upward so that the core mold 5 and the cavity mold 6 are separated from each other, with the molten resin 100 adhering to the core mold 5. In this way, the molten resin 100 is formed as the molded body 300. The molded body 300 is provided with the chamfered surface 201a formed by the inclined surface forming portion 44 of the fixing sleeve 43.

Note that, also when the fixing sleeve 43 is used, as in the above-mentioned case, the cut-off piece 101 can be held in the molded hole 201.

Further, in the example illustrated hereinabove, the fixing sleeve 43 is arranged in a manner of being fixed to the cavity mold 6. However, reversely, the fixing sleeve 43 may be arranged in a manner of being fixed to the core mold 5 so that the core pin 27 is supported to be slidable with respect to the fixing sleeve 43.

As described above, when the fixing sleeve 43 provided with the inclined surface forming portion 44 is used, the inclined surface (chamfered surface) can be easily formed with respect to the molded body 300. In addition, the inclined surface can be formed with respect to the molded body 300 with a high degree of freedom in size.

### (First Modification)

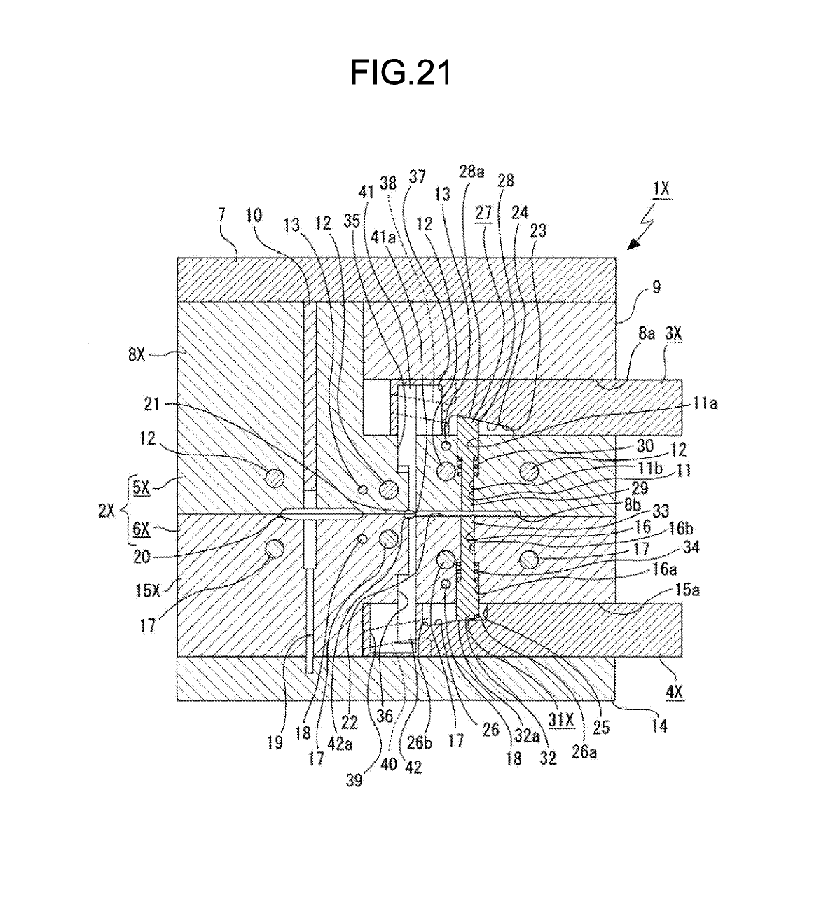

In the following, description is made of a first modification of the molding apparatus (refer to FIGS. 21 to 26).

Note that, the molding apparatus according to the first modification described below is different from the above-mentioned molding apparatus 1 only in that a cutting pin and a receiving pin are provided in addition to the core pin and the cavity pin. Thus, regarding the molding apparatus according to the first modification, detailed description is made only of parts different from those of the molding apparatus 1, and the other parts are denoted by the same reference symbols as the reference symbols of the same parts as those of the molding apparatus 1 to omit redundant description.

A molding apparatus 1X according to the first modification includes an injection-molding mold assembly 2X, a first slider 3X, and a second slider 4X (refer to FIG. 21).

The injection-molding mold assembly 2X is formed of a core mold 5X and a cavity mold 6X that can be moved toward and away from each other in the vertical direction. The core mold 5X is a movable mold to be moved upward and downward above the cavity mold 6X, and the cavity mold 6X is a fixed mold.

The core mold 5X includes the base portion 7, a molding portion 8X, the fixed portion 9, and the insertion portion 10.

The molding portion 8X is provided with the sliding recessed portion 8a, the filling recessed portion 8b, and the pin support hole 11. In addition, the molding portion 8X is provided with a pin arranging hole 35 which is formed aside the pin support hole 11 and vertically extends.

The cavity mold 6X includes the base portion 14 and a molding portion 15X.

The molding portion 15X is provided with the sliding recessed portion 15a and the pin support hole 16. In addition, the molding portion 15X is provided with a pin arranging hole 36 which is formed aside the pin support hole 16 and vertically extends.

The first slider 3X is supported in the sliding recessed portion 8a of the core mold 5X so as to be movable in the horizontal direction. The first slider 3X is provided with the core-pin cam portion 23 and a moving recessed portion 37 which are opened downward. The first slider 3X is provided with a cutting-pin cam portion 38.

The second slider 4X is supported in the sliding recessed portion 15a of the cavity mold 6X so as to be movable in the horizontal direction. The second slider 4X is provided with the cavity-pin cam portion 25 and a moving recessed portion 39 which are opened upward. The second slider 4X is provided with a receiving-pin cam portion 40.

In the pin arranging hole 35 of the core mold 5X, a cutting pin 41 is supported to be movable in the vertical direction. An edge on one side of a lower end portion of the cutting pin 41 is provided as a cutter 41a, and an upper end of the cutting pin 41 is inserted in the moving recessed portion 37 of the first slider 3X and is engaged to be slidable with respect to the cutting-pin cam portion 38. Thus, when the first slider 3X is moved in the horizontal direction, an engagement position of the cutting pin 41 with respect to the cutting-pin cam portion 38 varies. In this way, the cutting pin 41 is moved in the vertical direction.

In the pin arranging hole 36 of the cavity mold 6X, a receiving pin 42 is supported to be movable in the vertical direction. A central axis of the receiving pin 42 corresponds to a central axis of the cutting pin 41. An upper surface of the receiving pin 42 is formed as a receiving surface 42a. A lower end portion of the receiving pin 42 is inserted in the moving recessed portion 39 of the second slider 4X and engaged to be slidable with respect to the receiving-pin cam portion 40. Thus, when the second slider 4X is moved in the horizontal direction, an engagement position of the receiving pin 42 with respect to the receiving-pin cam portion 40 varies. In this way, the receiving pin 42 is moved in the vertical direction.

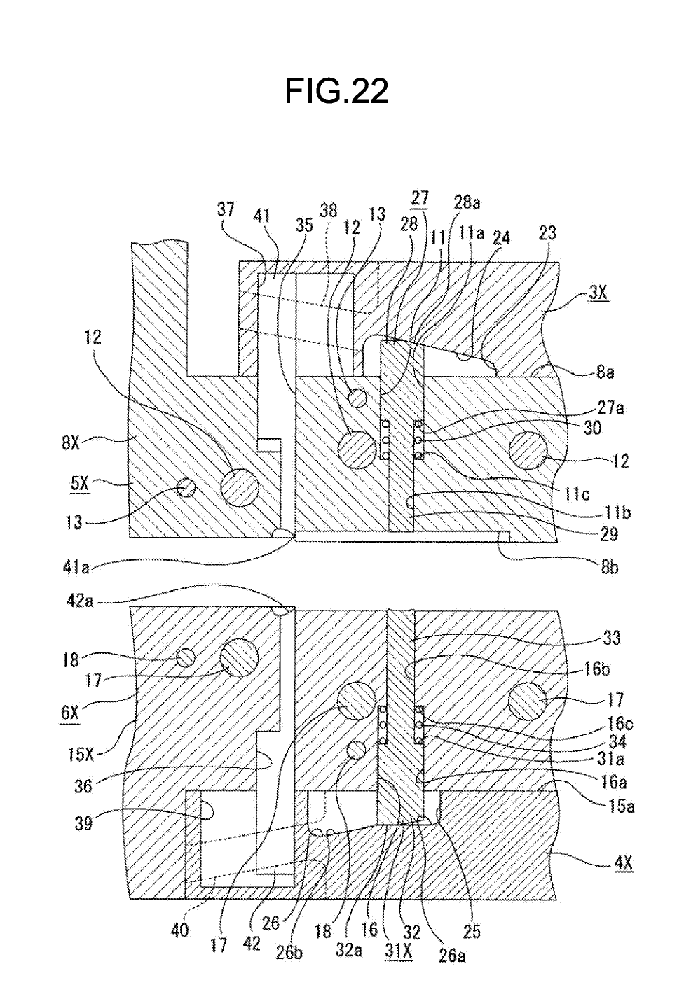

In the following, description is made of an operation of the molding apparatus 1X (refer to FIGS. 22 to 26).

In the initial state, the first slider 3X is held at a right moving end, and both the core pin 27 and the cutting pin 41 are held at respective upper moving ends (refer to FIG. 22). At this time, the cutter 41a of the cutting pin 41 is positioned at an interface between the gate 21 and the cavity 22.

In the initial state, the second slider 4X is held at a left moving end, and both the cavity pin 31 and the receiving pin 42 are held at respective upper moving ends. At this time, the receiving surface 42a of the receiving pin 42 is positioned at a lower end of the gate 21.

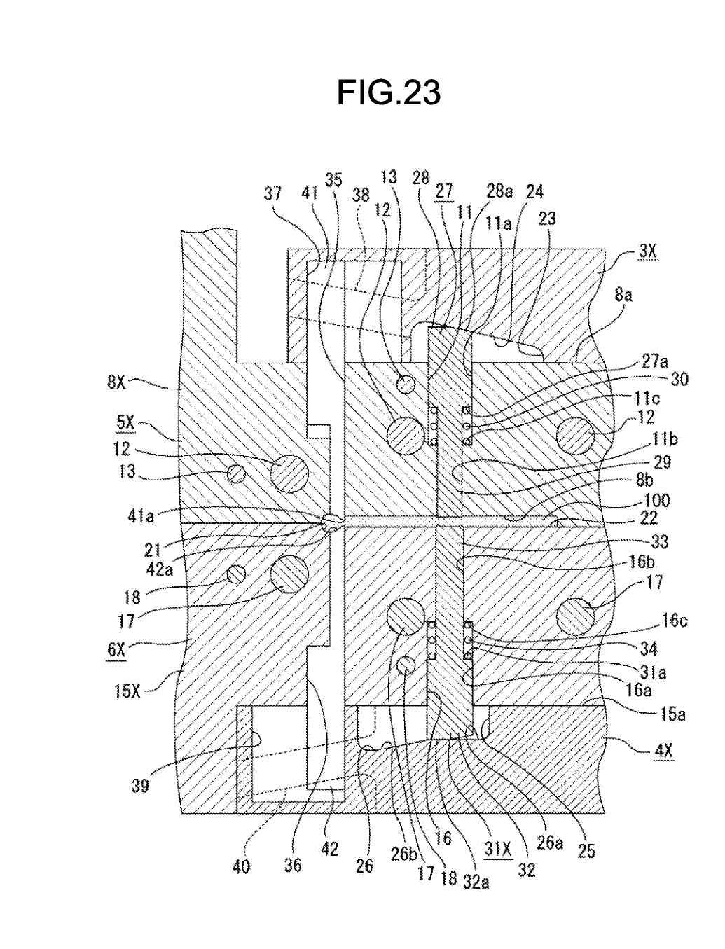

In the initial state, when the core mold 5X is moved downward so as to be fitted against and clamped to the cavity mold 6X, the molten resin 100 is filled from the resin storage tank through the sprue 19, the runner 20, and the gate 21 into the cavity 22 (refer to FIG. 23). At this time, the heaters 12, 12, . . . , and 17, 17, . . . are energized, and the temperature controllers 13, 13, 18, and 18 respectively monitor the temperatures of the heaters 12, 12, . . . and 17, 17, . . . so as to control temperatures of the core mold 5X and the cavity mold 6X.

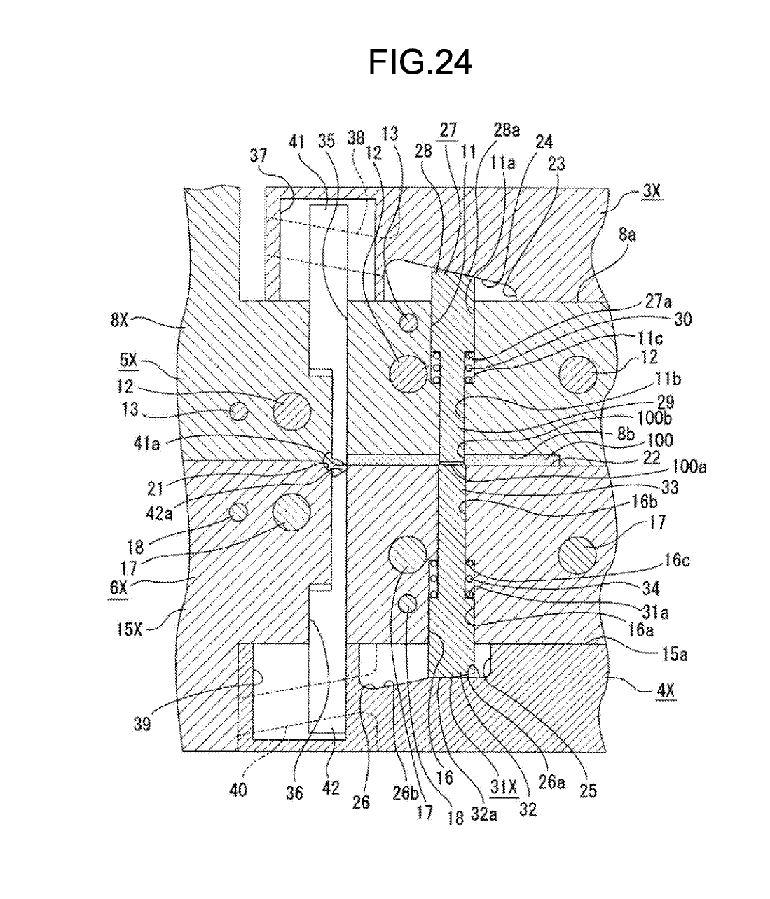

After the molten resin 100 has been filled in the cavity 22, the first slider 3X is moved to the left and stopped at a predetermined position before the molten resin 100 is cured (refer to FIG. 24). When the first slider 3X is moved to the left, the core pin 27 is moved downward to compress the part 100a of the molten resin 100. Simultaneously, the engagement position of the cutting pin 41 with respect to the cutting-pin cam portion 38 varies, and the cutting pin 41 is moved downward in accordance therewith. As a result, the cutter 41a partially cuts into another part of the molten resin 100, which is positioned at the interface between the gate 21 and the cavity 22.

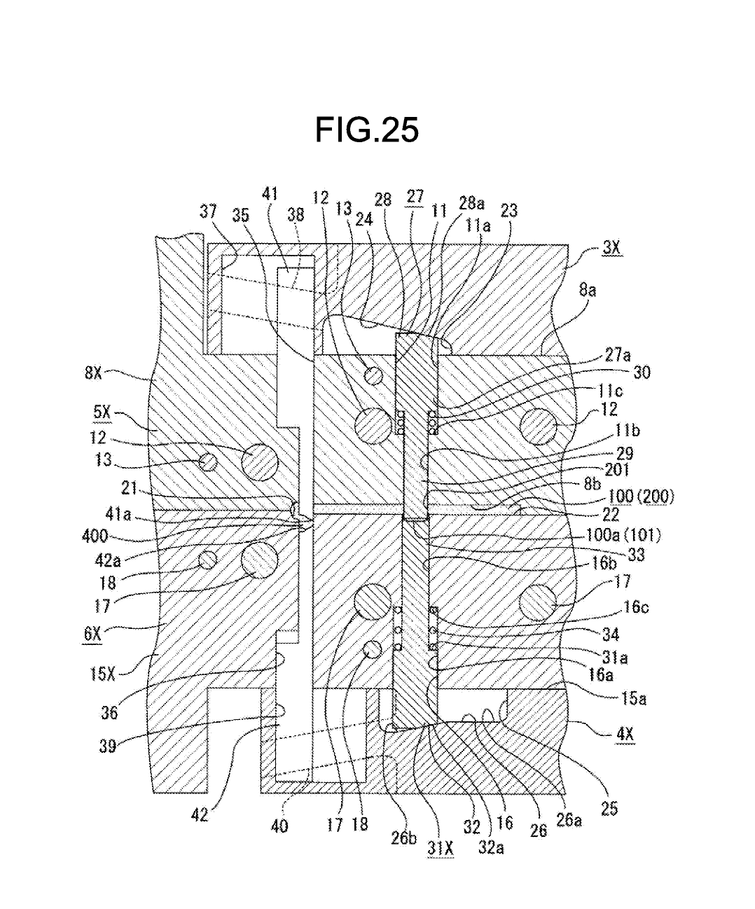

Next, under the state in which curing of the molten resin 100 has proceeded, specifically, under the state immediately before the molten resin 100 is cured, the first slider 3X is moved to the left again, and the second slider 4X is moved to the right (refer to FIG. 25). When the first slider 3X is moved to the left again and the second slider 4X is moved to the right, the core pin 27 and the cavity pin 31 are moved downward in accordance therewith so as to cut off the part 100a of the molten resin 100. In this way, the molded hole 201 is formed.

Simultaneously, the engagement position of the cutting pin 41 with respect to the cutting-pin cam portion 38 varies, and the cutting pin 41 is moved further downward in accordance therewith. In addition, the engagement position of the receiving-pin cam portion 40 with respect to the receiving pin 42 varies, and the receiving pin 42 is moved downward in accordance therewith. As a result, the cutter 41a cuts off the other part of the molten resin 100, which is positioned at the interface between the gate 21 and the cavity 22.

Note that, when the molten resin 100 is filled in the cavity 22, the heaters 12, 12, . . . , and 17, 17, . . . are energized as described above so as to suppress a cooling speed of the filled molten resin 100.

In this way, a time period until the molten resin 100 is cured can be prolonged. With this, the part 100a of the molten resin 100 can be compressed in an optimum state, that is, an uncured state. In addition, in this optimum state, that is, the uncured state, the molded hole 201 is formed by cutting off the part 100a of the molten resin 100. As a result, the molded hole 201 can be processed with higher accuracy.

Further, when the time period until the molten resin 100 is cured can be prolonged, the other part of the molten resin 100, which is positioned at the interface between the gate 21 and the cavity 22, can be cut off in the optimum state, that is, the uncured state. As a result, a cut surface can be processed with higher accuracy.

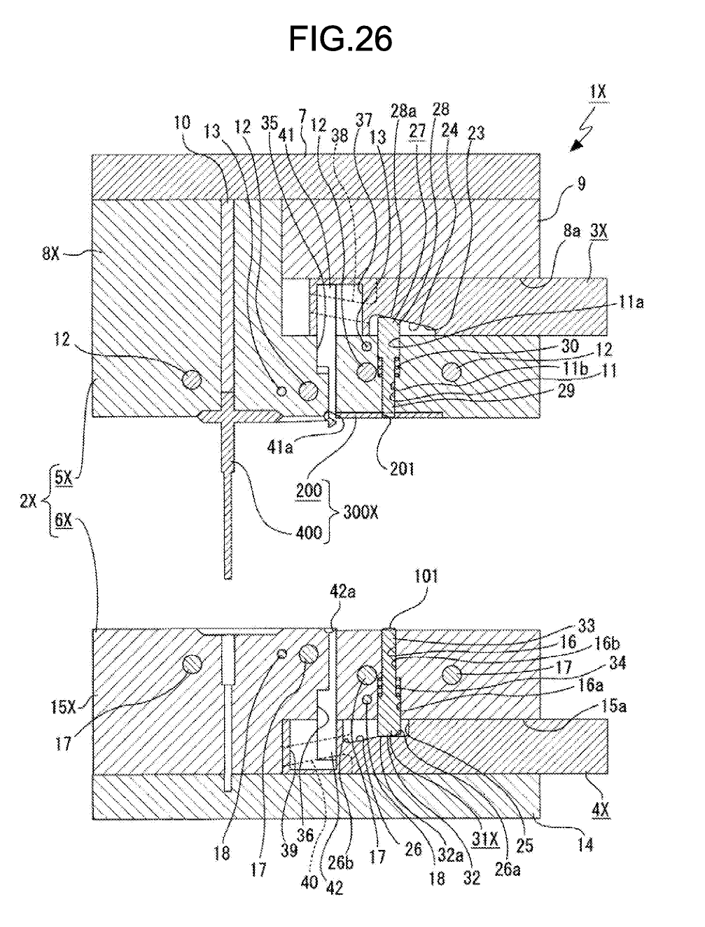

After the molten resin 100 has been cured, the core mold 5X is moved upward so that the core mold 5X and the cavity mold 6X are separated from each other. Then, the first slider 3X and the second slider 4X are moved to the positions in the initial state. In accordance therewith, the core pin 27, the cavity pin 31, the cutting pin 41, and the receiving pin 42 are moved upward to the positions in the initial state (refer to FIG. 26).

Under a state in which the core mold 5X and the cavity mold 6X have been separated from each other, the molten resin 100 has been cured and a molded body 300X has been formed. The molded body 300X is formed of the molded product 200 which is to be used as a product and provided with the molded hole 201, and the resin cured product 400 formed of the molten resin 100 that has remained and has been cured in the sprue 19, the runner 20, and the gate 21, the molded product 200 and the resin cured product 400 being separated from each other.

At this time, the filling recessed portion 8b that has been formed in the core mold 5X allows the molded product 200 to adhere to the core mold 5X. In addition, the holding recessed portion 33c that has been formed in the cavity pin 31 allows the cut-off piece 101 to adhere to the cavity pin 31. Further, the resin cured product 400 adheres to the core mold 5X or the cavity mold 6X.

The molded product 200 is taken out from the core mold 5X by being pushed out by an ejector pin supported in the core mold 5X. The resin cured product 400 is taken out from the core mold 5X or the cavity mold 6X by being pushed out by an ejector pin or by being sucked by a sucker. The cut-off piece 101 is taken out from the cavity pin 31 by being sucked by the sucker.

At this time, suction pressure of the sucker has been measured by a measurer. When the measurer detects suction pressure equal to or more than a predetermined value, it is judged that the sucker has performed a sucking operation with respect to the cut-off piece 101. Based on this judgment result, the core mold 5X and the cavity mold 6X are clamped to each other.

In this way, the cut-off piece 101 is prevented from being nipped between the core mold 5X and the cavity mold 6X. Further, when the resin cured product 400 is sucked by the sucker, the resin cured product 400 is prevented from being nipped between the core mold 5X and the cavity mold 6X.

Further, in the molding apparatus 1X, the core mold 5X is provided with the filling recessed portion 8b, and the cavity pin 31 is provided with the holding recessed portion 33c configured to hold the cut-off piece 101. With this, after the core mold 5X and the cavity mold 6X have been separated from each other, the molded product 200 remains in the filling recessed portion 8b and adheres to the core mold 5X, and the cut-off piece 101 remains in the holding recessed portion 33c and adheres to the cavity pin 31.

In this way, the molded product 200 and the cut-off piece 101 are respectively taken out from the core mold 5X and the cavity pin 31 separate from each other. Thus, the molded product 200 and the cut-off piece 101 can be simultaneously taken out. As a result, the molding operation of the molded product 200 can be performed within a shorter operating time period.

Further, the molding apparatus 1X is provided with the first slider 3X including the core-pin cam portion 23 and the second slider 4X including the cavity-pin cam portion 25. By operating the first slider 3X and the second slider 4X, the core pin 27 and the cavity pin 31 are respectively moved in necessary directions so that the molded hole 201 is formed in the molded product 200.

In this way, the core pin 27 and the cavity pin 31 can be reliably moved with a simple mechanism. As a result, the mechanism of the molding apparatus 1X can be simplified and manufacturing cost can be reduced.

Still further, the molding apparatus 1X is provided with the first urging spring 30 configured to urge the core pin 27 in the direction in which the core pin 27 comes into contact with the core-pin cam portion 23 of the first slider 3X, and the second urging spring 34 configured to urge the cavity pin 31 in the direction in which the cavity pin 31 comes into contact with the cavity-pin cam portion 25 of the second slider 4X.

With this, high positional accuracies of the core pin 27 and the cavity pin 31 respectively with respect to the core mold 5X and the cavity mold 6X can be secured. As a result, the core pin 27 and the cavity pin 31 can be operated with higher reliability during the molding operation of the molded product 200.

Note that, in the molding apparatus 1X, the cutting edge 29a projected to the cavity pin 31 side is formed along the outer peripheral portion of the distal end portion of the core pin 27.

With this, when the molded hole 201 is formed in the molded product 200 by the cutting edge 29a, a condition of the cut surface is satisfactorily secured. As a result, the molded hole 201 can be processed with higher accuracy.

Further, the cutting portion 33a projected to the core pin 27 side is formed along the outer peripheral portion of the distal end portion of the cavity pin 31.

With this, when the molded hole 201 is formed in the molded product 200 by the cutting portion 33a, the condition of the cut surface is more satisfactorily secured. As a result, the molded hole 201 can be processed with much higher accuracy.

Further, the molding apparatus 1X is further provided with the cutting pin 41 and the receiving pin 42. With this, when the molded hole 201 is formed by cutting off the molten resin 100, the molten resin 100 is cut off at the interface between the gate 21 and the cavity 22 so as to separate the molded product 200 and the resin cured product 400 from each other.

Thus, it is unnecessary to perform a post-step of cutting off the molded product 200 from the molten resin 100 filled and cured in the gate 21. As a result, the molding operation of the molded product 200 can be performed with higher operating efficiency and within a shorter operating time period.

Further, the core pin 27 and the cutting pin 41 are moved in the vertical direction in accordance with the movement of the first slider 3X, and the cavity pin 31 and the receiving pin 42 are moved in the vertical direction in accordance with the movement of the second slider 4X.

In other words, two sliders of the first slider 3X and the second slider 4X move four pins of the core pin 27, the cutting pin 41, the cavity pin 31, and the receiving pin 42. Thus, the mechanism can be simplified, and hence manufacturing cost can be reduced. In addition, the molding operation of the molded product 200 can be performed with higher operating efficiency and within a shorter operating time period.

### (Second Modification)

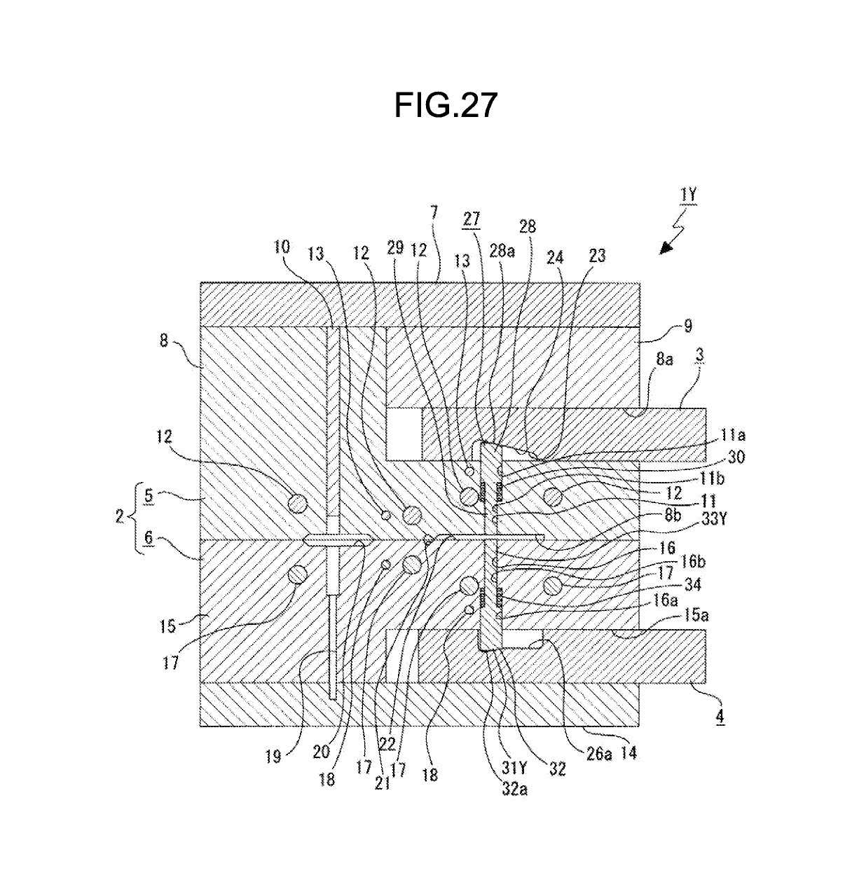

In the following, description is made of a second modification of the molding apparatus (refer to FIGS. 27 to 43).

Note that, the molding apparatus according to the second modification described below is different from the above-mentioned molding apparatus 1 only in shape of the cavity pin and method of forming the molded hole. Thus, regarding the molding apparatus according to the second modification, detailed description is made only of parts different from those of the molding apparatus 1, and the other parts are denoted by the same reference symbols as the reference symbols of the same parts as those of the molding apparatus 1 to omit redundant description.

A molding apparatus 1Y includes the injection-molding mold assembly 2, the first slider 3, and the second slider 4 (refer to FIG. 27). Note that, in the molding apparatus 1Y, the core pin 27 may be fixed, and in this case, the first slider 3 or the first urging spring 30 needs not be provided.

In the pin support hole 16 of the cavity mold 6, a cavity pin 31Y is supported to be movable in the vertical direction. A central axis of the cavity pin 31Y corresponds to the central axis of the core pin 27.

The cavity pin 31Y is formed of the large diameter shaft portion 32 positioned on the lower side and a small diameter shaft portion 33Y positioned on the upper side and having an outer diameter smaller than that of the large diameter shaft portion 32. The lower end portion of the large diameter shaft portion 32 is inserted in the cavity-pin cam portion 25 of the second slider 4.

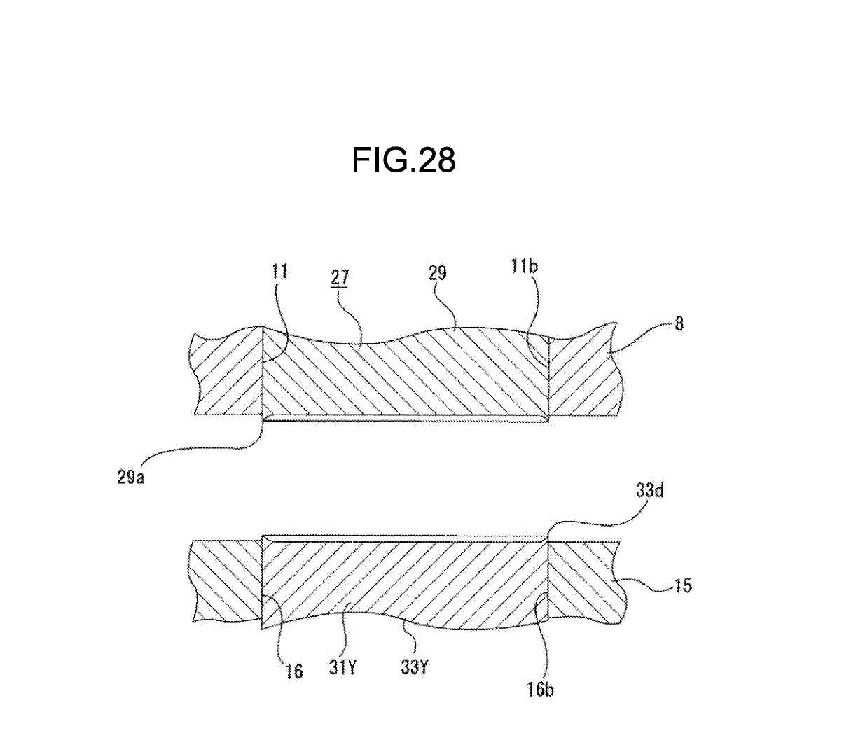

An outer diameter of the small diameter shaft portion 33Y is set to be equal to an outer diameter of the small diameter shaft portion 29 of the core pin 27 (refer to FIG. 28). A cutting portion 33d projected upward is formed along an outer peripheral portion of an upper end portion of the small diameter shaft portion 33Y. The cutting portion 33d is positioned directly below the cutting edge 29a provided to the core pin 27.

### (Operation of Molding Apparatus)

In the following, description is made of an operation of the molding apparatus 1Y (refer to FIGS. 28 to 39).

In the initial state, the first slider 3 is held at the right moving end, and the core pin 27 is held at the upper moving end. At this time, the cutting edge 29a of the core pin 27 is projected downward with respect to the pin support hole 11 (refer to FIG. 28).

In the initial state, the second slider 4 is also held at a right moving end, and the cavity pin 31Y is held at a lower moving end. At this time, the cutting portion 33d of the cavity pin 31Y is projected upward with respect to the pin support hole 16.

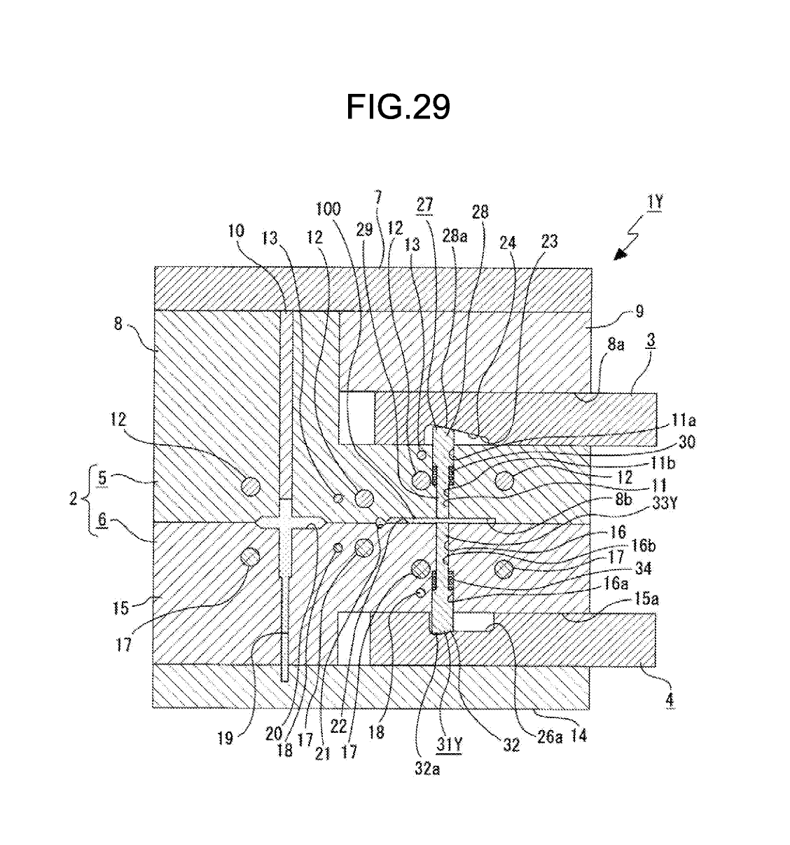

In the initial state, when the core mold 5 is moved downward so that the core mold 5 is fitted against and clamped to the cavity mold 6, the sprue 19, the runner 20, and the gate 21, and the cavity 22 are formed (refer to FIG. 29).

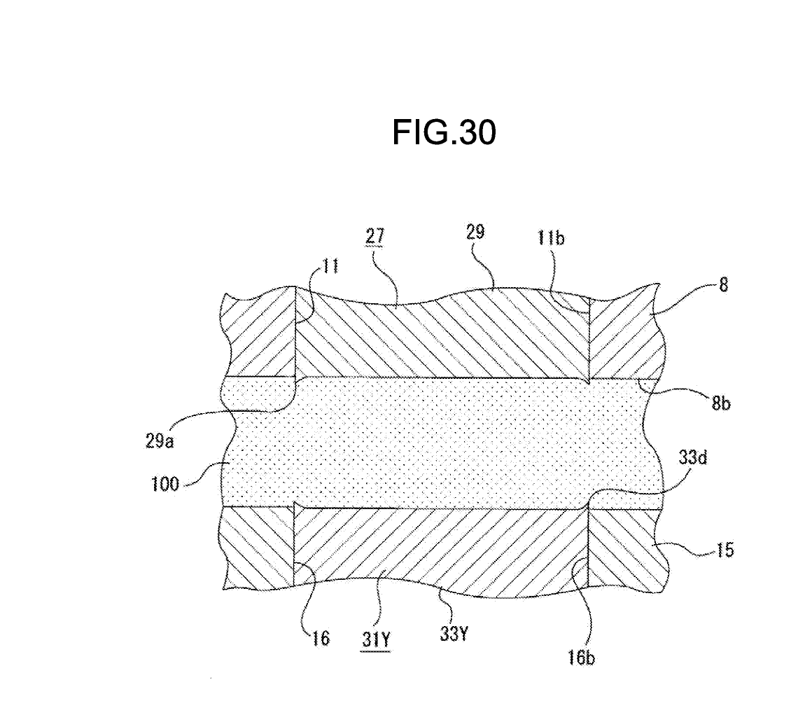

After the core mold 5 has been fitted against and clamped to the cavity mold 6 so that the sprue 19, the runner 20, and the gate 21, and the cavity 22 are formed, the molten resin 100 is filled from a resin storage tank (not shown) through the sprue 19, the runner 20, and the gate 21 into the cavity 22 (refer to FIGS. 29 and 30). At this time, the heaters 12, 12, . . . , and 17, 17, . . . are energized, and the temperature controllers 13, 13, 18, and 18 respectively monitor the temperatures of the heaters 12, 12, . . . and 17, 17, . . . so as to control the temperatures of the core mold 5 and the cavity mold 6.

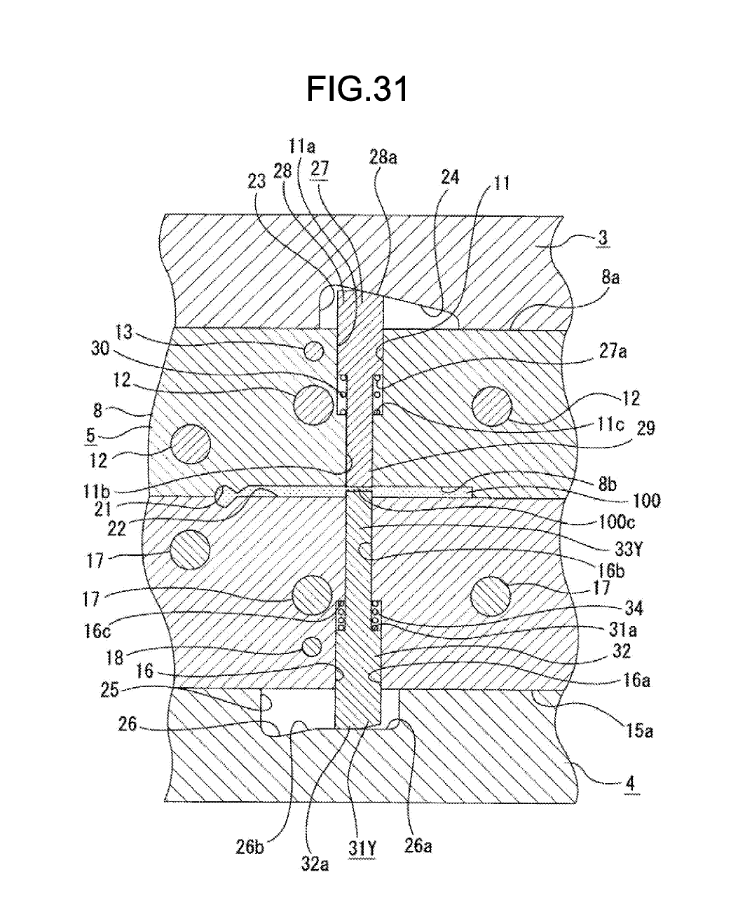

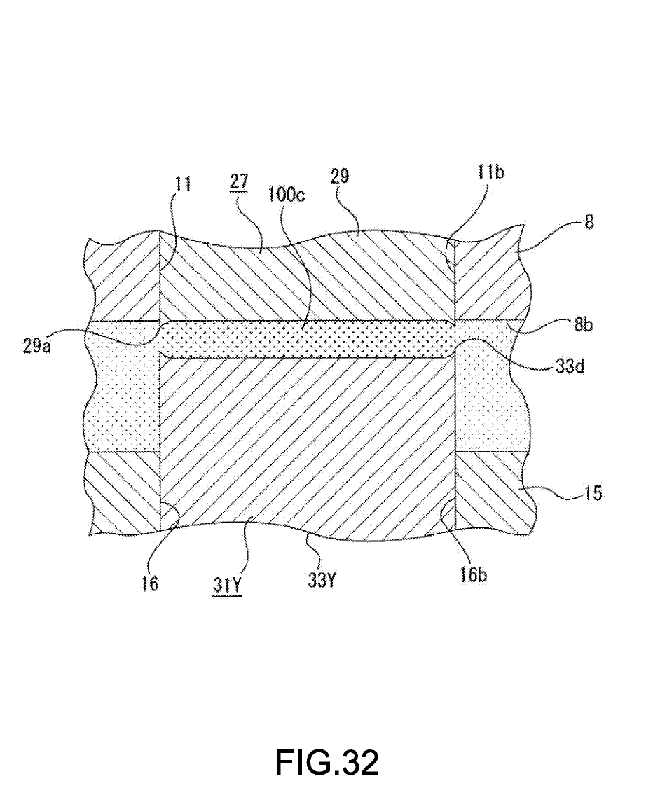

After the molten resin 100 has been filled in the cavity 22, the second slider 4 is moved to the left and stopped at a position at which the cam sliding surface 32a of the cavity pin 31Y is engaged with the inoperative portion 26a of the cam surface 26 before the molten resin 100 is cured (refer to FIG. 31). When the second slider 4 is moved to the left, the cam surface 26 is slid against the cam sliding surface 32a of the cavity pin 31Y, and in accordance therewith, the cavity pin 31Y is moved upward (refer to FIG. 32). In this way, a part of the molten resin 100 is compressed to be formed as a resin compressed portion 100c. As a result, a molded recessed portion 100d opened downward is formed in the molten resin 100.

The cutting portion 33d of the cavity pin 31Y that has been moved upward is stopped at a position of having come close to the cutting edge 29a of the core pin 27. At this time, a clearance between a distal end of the cutting portion 33d of the cavity pin 31Y and a distal end of the cutting edge 29a of the core pin 27 is set, for example, from 0.3 mm to 0.5 mm.

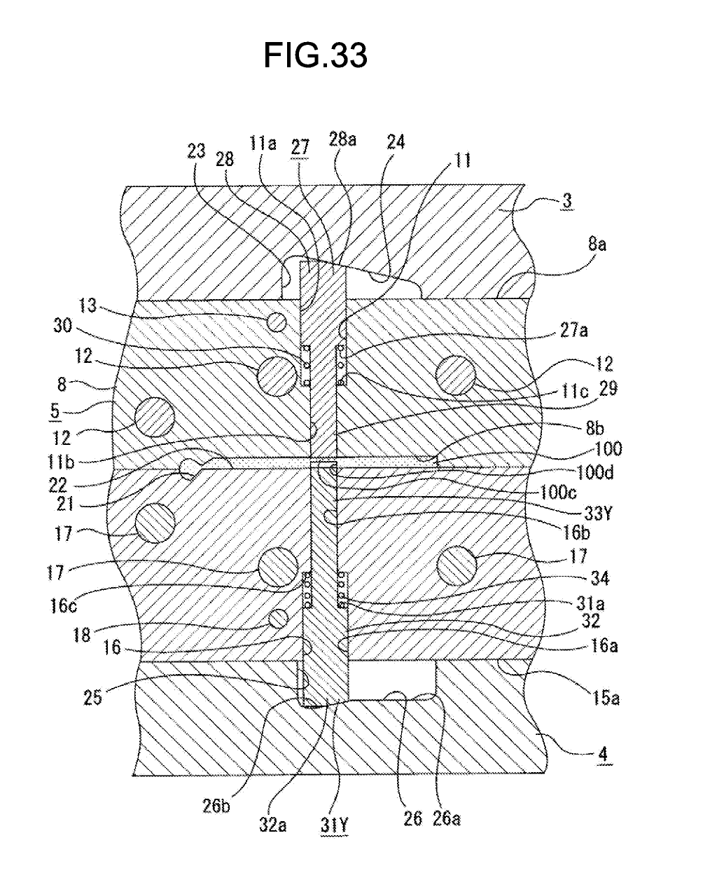

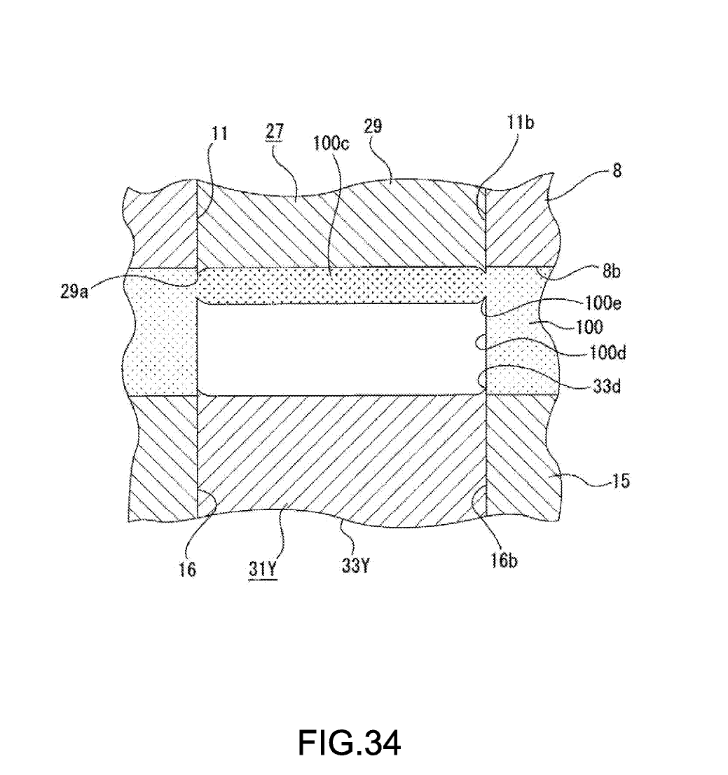

Next, under a state in which the molten resin 100 has been cured, the second slider 4 is moved to the right (refer to FIG. 33). When the second slider 4 is moved to the right, the cam surface 26 is slid against the cam sliding surface 32a of the cavity pin 31Y, and in accordance therewith, the cavity pin 31Y is moved downward to the position in the initial state (refer to FIG. 34).

Note that, when the molten resin 100 is filled in the cavity 22, the heaters 12, 12, . . . , and 17, 17, . . . are energized as described above so as to suppress a cooling speed of the filled molten resin 100.

In this way, a time period until the molten resin 100 is cured can be prolonged. With this, the part of the molten resin 100 can be formed as the resin compressed portion 100c in an optimum state, that is, an uncured state.

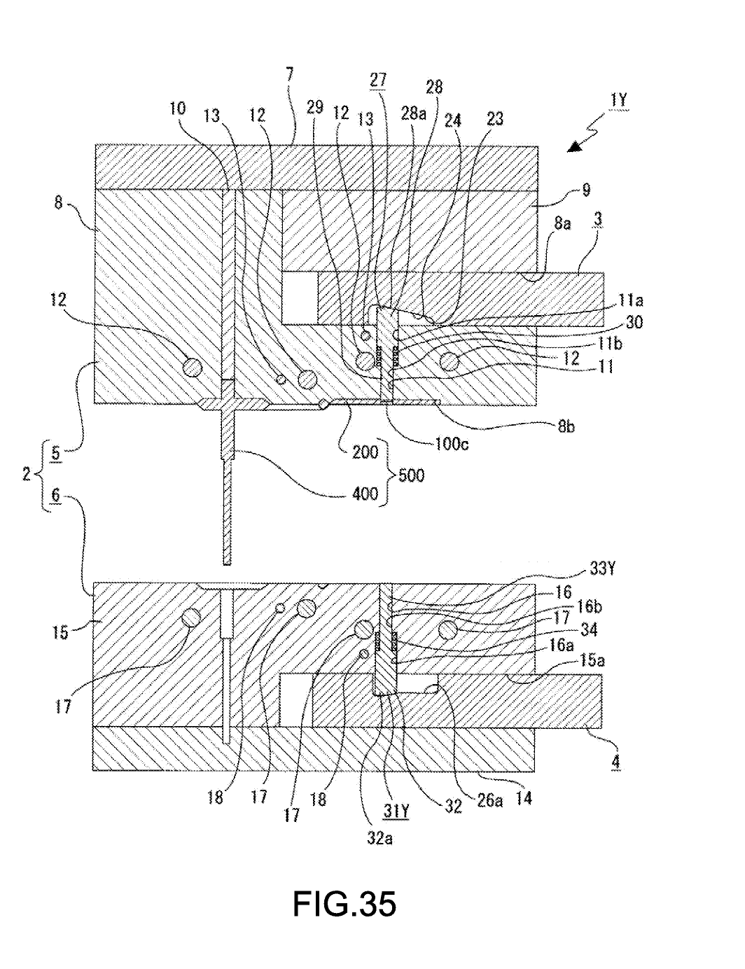

Next, the core mold 5 is moved upward so that the core mold 5 and the cavity mold 6 are separated from each other (refer to FIG. 35).

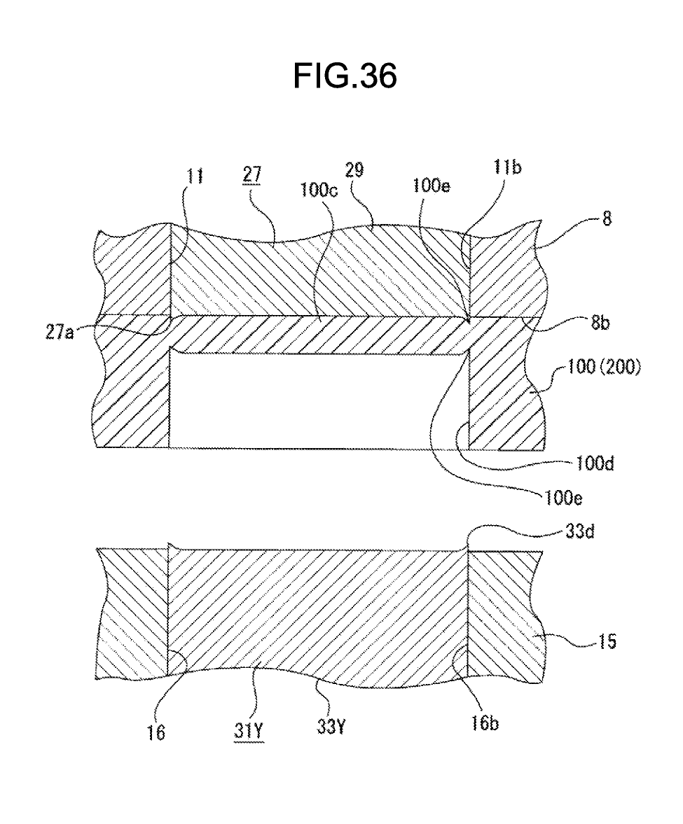

At this time, the filling recessed portion 8b that has been formed in the core mold 5 allows the molten resin 100 to adhere to the core mold 5 (refer to FIGS. 35 and 36).

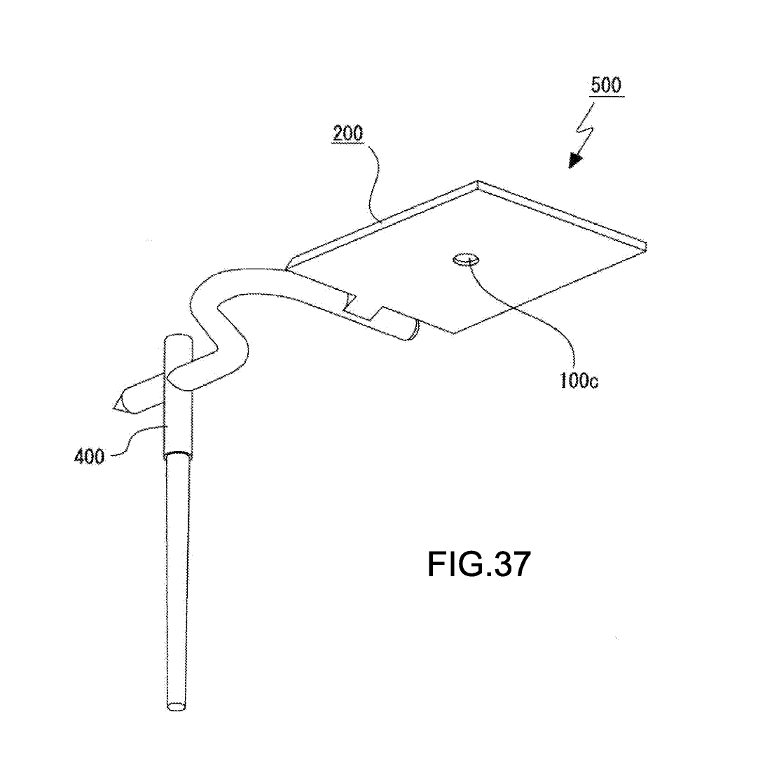

Under the state in which the core mold 5 and the cavity mold 6 have been separated from each other, the molten resin 100 has been cured and a molded body 500 has been formed. The molded body 500 is formed of an integral piece of a part to be provided as the molded product 200 which is to be used as a product, the resin compressed portion 100c, and the resin cured product 400 formed of the molten resin 100 that has remained and has been cured in the sprue 19, the runner 20, and the gate 21 (refer to FIG. 37).

The molded body 500 is taken out from the core mold 5 by being pushed out by the ejector pin supported in the core mold 5. After the molded body 500 has been taken out from the core mold 5, the molded body 500 is set to a receiving table 600 of a cutting apparatus.

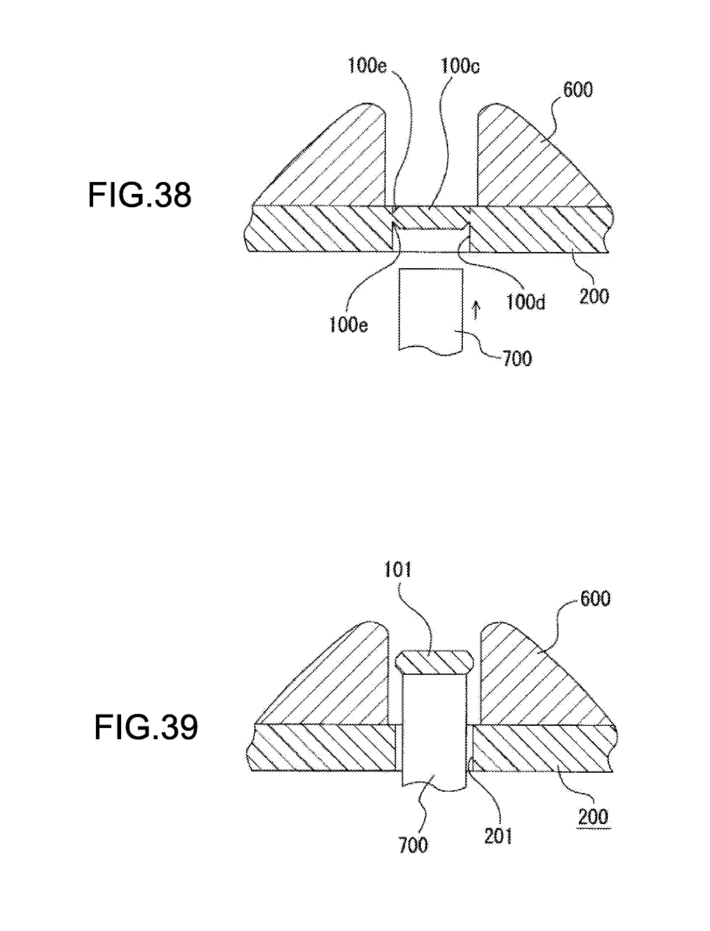

In the resin compressed portion 100c of the molded body 500, notch portions 100e and 100e are formed at parts continuous with the part to be provided as the molded product 200 by the cutting portion 33d of the cavity pin 31Y and the cutting edge 29a of the core pin 27 (refer to FIG. 38).

After the molded body 500 has been set to the receiving table 600 of the cutting apparatus, the resin compressed portion 100c is pressed and cut off by a punch 700 provided to the cutting apparatus so as to form the molded hole 201 (refer to FIG. 39). Simultaneously, the resin cured product 400 is cut off by a cutter and the like provided to the cutting apparatus. In this way, the molded product 200 having the molded hole 201 is formed.

As described above, in the molding apparatus 1Y, the resin compressed portion 100c is cut off by the punch 700, and simultaneously, the resin cured product 400 is cut off. Thus, a time period for forming the molded product 200 is not prolonged even when forming the molded hole 201. As a result, the molded product 200 can be formed within a shorter time period.

The resin compressed portion 100c, which is the thus cut-off part of the molded body 500, is used as the cut-off piece 101.

When the resin compressed portion 100c is pressed and cut off by the punch 700, the resin compressed portion 100c is easily cut off and smooth cut surfaces (broken surfaces) are formed because the notch portions 100e and 100e are formed at the parts of the resin compressed portion 100c, which are continuous with the part to be provided as the molded product 200.

The molding apparatus 1Y is provided with the second slider 4 including the cavity-pin cam portion 25. By operating the second slider 4, the cavity pin 31Y is moved in a necessary direction so that the molded hole 201 is formed in the molded product 200.

In this way, the cavity pin 31Y can be reliably moved with a simple mechanism. As a result, the mechanism of the molding apparatus 1Y can be simplified and manufacturing cost can be reduced.

Note that, in the example illustrated in the second modification hereinabove, the molded product 200 is formed by moving the cavity pin 31Y while fixing the core pin 27. However, reversely, the molded product 200 may be formed by moving the core pin 27 while fixing the cavity pin 31Y. Alternatively, the molded product 200 may be formed by moving the core pin 27 and the cavity pin 31Y by respective predetermined amounts.

Further, the molding apparatus 1Y is provided with the first urging spring 30 configured to urge the core pin 27 in a direction in which the core pin 27 comes into contact with the core-pin cam portion 23 of the first slider 3, and the second urging spring 34 configured to urge the cavity pin 31Y in a direction in which the cavity pin 31Y comes into contact with the cavity-pin cam portion 25 of the second slider 4.

With this, high positional accuracies of the core pin 27 and the cavity pin 31Y respectively with respect to the core mold 5 and the cavity mold 6 can be secured. As a result, the core pin 27 and the cavity pin 31Y can be operated with higher reliability during the molding operation of the molded product 200.

Note that, in the molding apparatus 1Y, the cutting edge 29a projected to the cavity pin 31Y side is formed along the outer peripheral portion of the distal end portion of the core pin 27.

With this, when the molded hole 201 is formed in the molded product 200 by the cutting edge 29a, the condition of the cut surface is satisfactorily secured. As a result, the molded hole 201 can be processed with higher accuracy.

Further, the cutting portion 33d projected to the core pin 27 side is formed along the outer peripheral portion of a distal end portion of the cavity pin 31Y.

With this, when the molded hole 201 is formed in the molded product 200 by the cutting portion 33d, the condition of the cut surface is more satisfactorily secured. As a result, the molded hole 201 can be processed with much higher accuracy.

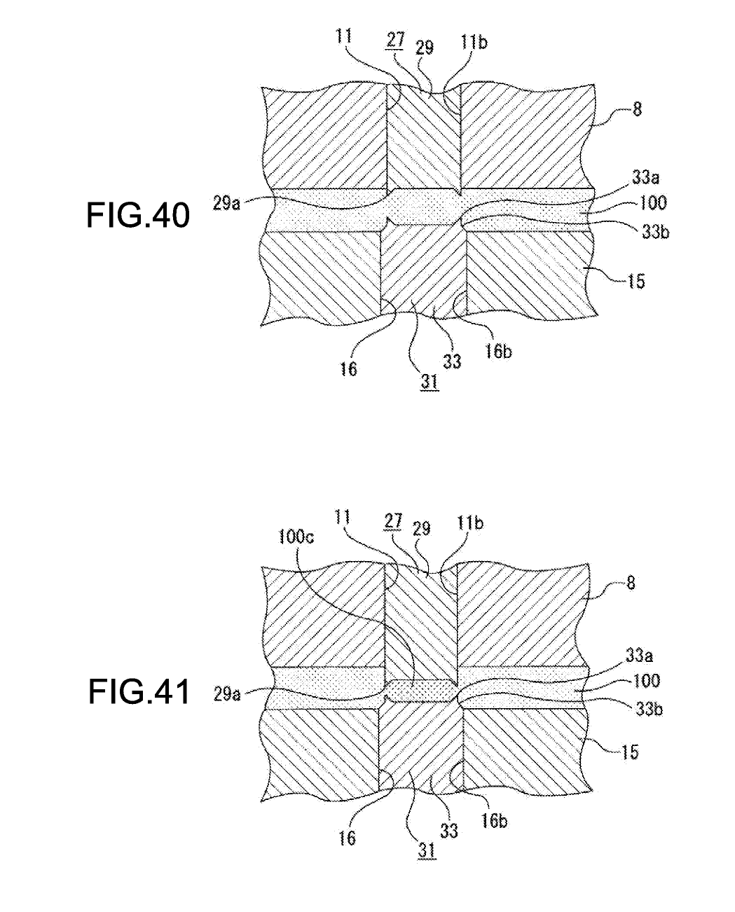

Note that, in the molding apparatus 1Y, the cavity pin 31 of the molding apparatus 1, which includes the surface forming portion 33b configured to form the chamfered surface 201a with respect to the molded product 200, may be used instead of the cavity pin 31Y (refer to FIGS. 40 to 43). Note that, the cavity pin 31 in this case needs not be provided with the holding recessed portion 33c.

When the cavity pin 31 is used, under the state in which the molten resin 100 has been filled in the cavity 22 (refer to FIG. 40), first, the core pin 27 is moved in a direction in which the core pin 27 comes close to the cavity pin 31 so as to form the resin compressed portion 100c (refer to FIG. 41).

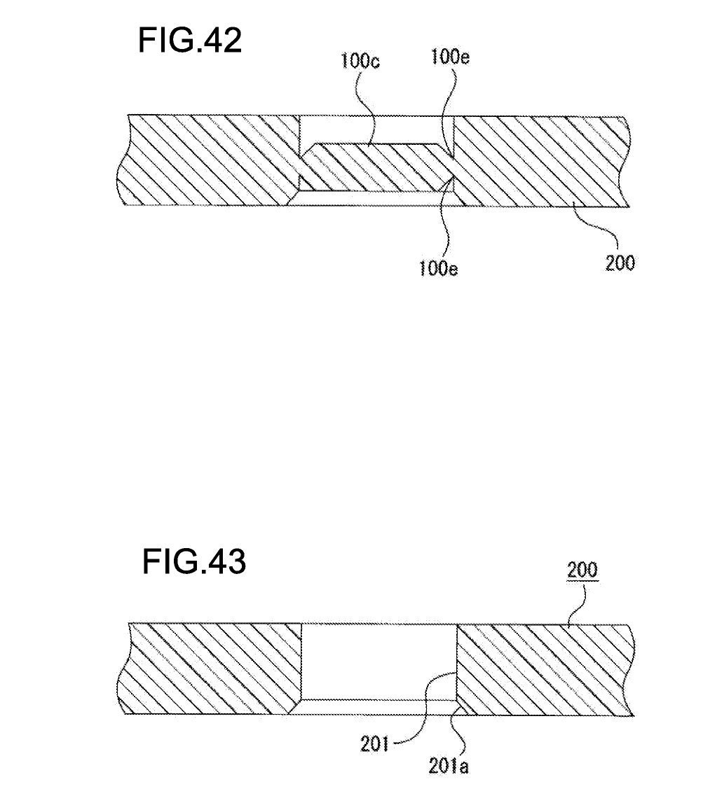

Next, after the core pin 27 has been moved in a direction in which the core pin 27 is separated from the cavity pin 31, the core mold 5 and the cavity mold 6 are separated from each other, and then the molded body 500 is taken out by the ejector pin (refer to FIG. 42). After that, the resin compressed portion 100c is pressed and cut off by the punch 700, and simultaneously, the resin cured product 400 is cut off. In this way, the molded product 200 is formed (refer to FIG. 43).

By forming the molded product 200 in this way, the chamfered surface 201a is formed along the inner rim of the molded hole 201 by the surface forming portion 33b of the cavity pin 31.

Note that, the core pin may be formed to have the surface forming portion, and the chamfered surface may be formed along the inner rim of the molded hole 201 by the surface forming portion of the core pin.

### (Summary)

As described hereinabove, in the molding apparatuses 1 and 1X, before the molten resin 100 is cured, at least one of the core pin 27 and the cavity pin 31 is moved to be pressed onto the molten resin 100 so that the part 100a of the molten resin 100 is compressed. By moving the core pin 27 and the cavity pin 31, the part 100a of the molten resin 100 thus compressed is cut off. In this way, the molded hole 201 is formed.

Thus, the molded hole 201 is formed after the molten resin 100 has been filled in the cavity 22, and hence it is unnecessary to use a large-scale heating apparatus or the like configured to perform rapid heating so as to prevent generation of weld lines. Thus, generation of weld lines is prevented without involving high manufacturing cost.

Further, in the molding apparatus 1Y, before the molten resin 100 is cured, at least one of the core pin 27 and the cavity pin 31Y is moved to be pressed onto the molten resin 100 so that a part of the molten resin 100 is compressed to be formed as the resin compressed portion 100c. Then, the resin compressed portion 100c is cut off by the punch 700. In this way, the molded hole 201 is formed.

Thus, the molded hole 201 is formed after the molten resin 100 has been filled in the cavity 22, and hence it is unnecessary to use a large-scale heating apparatus or the like configured to perform rapid heating so as to prevent generation of weld lines. Thus, generation of weld lines is prevented without involving high manufacturing cost.

### (Present Disclosure)

The present disclosure may employ the following configurations.

(1) A molding apparatus, including:

a cavity mold fixed at a predetermined position;

a core mold configured to be fitted against and clamped to the cavity mold so that a cavity in which molten resin is to be filled through a gate is formed;

a core pin supported to be movable in a direction in which the cavity mold and the core mold are moved toward and away from each other in the core mold and configured to form a molded hole in a molded product to be formed by curing the molten resin that has been filled in the cavity; and

a cavity pin supported to be movable in the direction in which the cavity mold and the core mold are moved toward and away from each other in the cavity mold, having a central axis corresponding to a central axis of the core pin, and configured to form the molded hole together with the core pin, in which

after the molten resin has been filled in the cavity, at least one of the core pin and the cavity pin is moved to be pressed onto the molten resin so that a part of the molten resin is compressed before the molten resin is cured, and

the molded hole is formed by cutting off the compressed part of the molten resin by moving the core pin and the cavity pin.

(2) The molding apparatus according to Item (1), in which

the core mold is provided with a filling recessed portion which forms a part of the cavity and in which the molten resin is to be filled,

the cavity pin has a distal end portion provided with a holding recessed portion configured to hold a cut-off piece remaining after the molded hole has been formed, and after the core mold has been separated from the cavity mold, the molded product remains in the filling recessed portion and adheres to the core mold, and the cut-off piece remains in the holding recessed portion and adheres to the cavity pin.

(3) The molding apparatus according to Item (2), further including:

a sucker configured to take out, from the cavity pin, the cut-off piece remaining after the molded hole has been formed; and

a measurer configured to measure suction pressure of the sucker at the time when the sucker sucks the cut-off piece,

in which the core mold and the cavity mold are clamped to each other when the measurer detects suction pressure equal to or more than a predetermined value.

(4) The molding apparatus according to any one of Items (1) to (3), further including:

a first slider which includes a core-pin cam portion engaged to be slidable with respect to the core pin so that the core pin is moved and which is supported to be movable in a predetermined direction in the core mold; and

a second slider which includes a cavity-pin cam portion engaged to be slidable with respect to the cavity pin so that the cavity pin is moved and which is supported to be movable in a predetermined direction in the cavity mold.

(5) The molding apparatus according to Item (4), further including:

a first urging spring configured to urge the core pin in a direction in which the core pin comes into contact with the core-pin cam portion of the first slider; and

a second urging spring configured to urge the cavity pin in a direction in which the cavity pin comes into contact with the cavity-pin cam portion of the second slider.

(6) The molding apparatus according to any one of Items (1) to (5), in which a cutting edge projected to the cavity pin side is formed along an outer peripheral portion of a distal end portion of the core pin.

(7) The molding apparatus according to Item (6), in which a cutting portion projected to the core pin side is formed along an outer peripheral portion of a distal end portion of the cavity pin.

(8) The molding apparatus according to any one of Items (1) to (7), further including a heater configured to suppress a cooling speed of the molten resin to be filled in the cavity.

(9) The molding apparatus according to any one of Items (1) to (8), further including:

a cutting pin supported to be movable in the direction in which the cavity mold and the core mold are moved toward and away from each other in the core mold and configured to cut off the molten resin at an interface between the gate and the cavity; and

a receiving pin supported to be movable in the direction in which the cavity mold and the core mold are moved toward and away from each other in the cavity mold and having a central axis corresponding to a central axis of the cutting pin,

in which the cutting pin cuts off the molten resin at the interface between the gate and the cavity when the molded hole is formed by cutting off the compressed part of the molten resin.

(10) The molding apparatus according to any one of Items (1) to (9), further including:

a cutting pin supported to be movable in the direction in which the cavity mold and the core mold are moved toward and away from each other in the core mold and configured to cut off the molten resin at an interface between the gate and the cavity; and

a receiving pin supported to be movable in the direction in which the cavity mold and the core mold are moved toward and away from each other in the cavity mold and having a central axis corresponding to a central axis of the cutting pin, in which

the first slider is provided with a cutting-pin cam portion engaged to be slidable with respect to the cutting pin so that the cutting pin is moved,

the second slider is provided with a receiving-pin cam portion engaged to be slidable with respect to the receiving pin so that the receiving pin is moved,

the core pin and the cutting pin are configured to be movable simultaneously with each other in accordance with movement of the first slider,

the cavity pin and the receiving pin are configured to be movable simultaneously with each other in accordance with movement of the second slider, and

the cutting pin cuts off the molten resin at the interface between the gate and the cavity when the molded hole is formed by cutting off the compressed part of the molten resin.

(11) The molding apparatus according to any one of Items (1) to (10), in which the part of the molten resin, which has been compressed and cut off, is formed as a cut-off piece, the cut-off piece being configured to be inserted in the molded hole by moving the core pin and the cavity pin and to be held in the molded hole.

(12) The molding apparatus according to Item (11), in which the cut-off piece held in the molded hole is configured to be taken out from the cavity together with the molded product.

(13) The molding apparatus according to any one of Items (1) to (12), further including a fixing sleeve formed into a cylindrical shape extending in the direction in which the cavity mold and the core mold are moved toward and away from each other, and having one axial end portion provided with an inclined surface forming portion which is inclined with respect to the direction in which the cavity mold and the core mold are moved toward and away from each other and which is configured to form an inclined surface with respect to the molded product, in which

the fixing sleeve is fixed in one of the core mold and the cavity mold under a state in which the inclined surface forming portion is positioned in the cavity, and

one of the core pin and the cavity pin is supported to be slidable with respect to the fixing sleeve under a state of being inserted in the fixing sleeve.

(14) A molding apparatus, including:

a cavity mold fixed at a predetermined position;

a core mold configured to be fitted against and clamped to the cavity mold so that a cavity in which molten resin is to be filled through a gate is formed;

a core pin supported to be movable in a direction in which the cavity mold and the core mold are moved toward and away from each other in the core mold and configured to form a resin compressed portion by compressing a part of the molten resin that has been filled in the cavity;

a cavity pin supported to be movable in the direction in which the cavity mold and the core mold are moved toward and away from each other in the cavity mold, having a central axis corresponding to a central axis of the core pin, and configured to form the resin compressed portion together with the core pin; and

a punch configured to be movable in the direction in which the cavity mold and the core mold are moved toward and away from each other and to form a molded hole in a molded product by cutting off the resin compressed portion, in which

after the molten resin has been filled in the cavity, at least one of the core pin and the cavity pin is moved to be pressed onto the molten resin so that the part of the molten resin is compressed to be formed as the resin compressed portion before the molten resin is cured, and

the molded hole is formed by cutting off the resin compressed portion by the punch.

(15) The molding apparatus according to Item (14), further including a slider which includes a cam portion engaged to be slidable with respect to the at least one of the core pin and the cavity pin so that the at least one of the core pin and the cavity pin is moved and which is supported to be movable in a predetermined direction in the at least one of the core pin and the cavity pin.

(16) The molding apparatus according to Item (15), further including an urging spring configured to urge the at least one of the core pin and the cavity pin in a direction in which the at least one of the core pin and the cavity pin comes into contact with the cam portion of the slider.

(17) A method of forming a molded product, including:

forming a cavity with a cavity mold fixed at a predetermined position and a core mold configured to be fitted against and clamped to the cavity mold;

filling molten resin through a gate into the cavity;

compressing a part of the molten resin by pressing at least one of a core pin and a cavity pin onto the molten resin before the molten resin is cured, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the compressed part of the molten resin by moving the core pin and the cavity pin.

(18) A molded product obtained by:

compressing a part of molten resin by pressing at least one of a core pin and a cavity pin onto the molten resin before the molten resin is cured, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the compressed part of the molten resin by moving the core pin and the cavity pin.

(19) A method of forming a molded product, including:

forming a cavity with a cavity mold fixed at a predetermined position and a core mold configured to be fitted against and clamped to the cavity mold;

filling molten resin through a gate into the cavity;

pressing at least one of a core pin and a cavity pin onto the molten resin before the molten resin is cured so that a part of the molten resin is compressed to be formed as a resin compressed portion, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole in a molded product by cutting off the resin compressed portion by a punch.

(20) A molded product obtained by:

pressing at least one of a core pin and a cavity pin onto molten resin before the molten resin is cured so that a part of the molten resin is compressed to be formed as a resin compressed portion, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and

forming a molded hole by cutting off the resin compressed portion by a punch.

The present disclosure contains subject matter related to that disclosed in Japanese Priority Patent Application JP 2011-144598 filed in the Japan Patent Office on Jun. 29, 2011, Japanese Priority Patent Application JP 2011-207914 filed in the Japan Patent Office on Sep. 22, 2011, and Japanese Priority Patent Application JP 2011-273682 filed in the Japan Patent Office on Dec. 14, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A molding apparatus, comprising:
a cavity mold fixed at a predetermined position;
a core mold configured to be fitted against and clamped to the cavity mold so that a cavity in which molten resin is to be filled through a gate is formed;
a core pin supported to be movable in a direction in which the cavity mold and the core mold are moved toward and away from each other in the core mold and configured to form a molded hole in a molded product to be formed by curing the molten resin that has been filled in the cavity; and
a cavity pin supported to be movable in the direction in which the cavity mold and the core mold are moved toward and away from each other in the cavity mold, having a central axis corresponding to a central axis of the core pin, and configured to form the molded hole together with the core pin, wherein
after the molten resin has been filled in the cavity, at least one of the core pin and the cavity pin is moved to be pressed onto the molten resin so that a part of the molten resin is compressed before the molten resin is cured, and
the molded hole is formed by cutting off the compressed part of the molten resin by moving the core pin and the cavity pin.

2. The molding apparatus according to claim 1, wherein
the core mold is provided with a filling recessed portion which forms a part of the cavity and in which the molten resin is to be filled,
the cavity pin has a distal end portion provided with a holding recessed portion configured to hold a cut-off piece remaining after the molded hole has been formed, and
after the core mold has been separated from the cavity mold, the molded product remains in the filling recessed portion and adheres to the core mold, and the cut-off piece remains in the holding recessed portion and adheres to the cavity pin.

3. The molding apparatus according to claim 2, further comprising:
a sucker configured to take out, from the cavity pin, the cut-off piece remaining after the molded hole has been formed; and
a measurer configured to measure suction pressure of the sucker at the time when the sucker sucks the cut-off piece,
wherein the core mold and the cavity mold are clamped to each other when the measurer detects suction pressure equal to or more than a predetermined value.

4. The molding apparatus according to claim 1, further comprising:
a first slider which includes a core-pin cam portion engaged to be slidable with respect to the core pin so that the core pin is moved and which is supported to be movable in a predetermined direction in the core mold; and
a second slider which includes a cavity-pin cam portion engaged to be slidable with respect to the cavity pin so that the cavity pin is moved and which is supported to be movable in a predetermined direction in the cavity mold.

5. The molding apparatus according to claim 4, further comprising:
a first urging spring configured to urge the core pin in a direction in which the core pin comes into contact with the core-pin cam portion of the first slider; and
a second urging spring configured to urge the cavity pin in a direction in which the cavity pin comes into contact with the cavity-pin cam portion of the second slider.

6. The molding apparatus according to claim 1, wherein a cutting edge projected to the cavity pin side is formed along an outer peripheral portion of a distal end portion of the core pin.

7. The molding apparatus according to claim 6, wherein a cutting portion projected to the core pin side is formed along an outer peripheral portion of a distal end portion of the cavity pin.

8. The molding apparatus according to claim 1, further comprising a heater configured to suppress a cooling speed of the molten resin to be filled in the cavity.

9. The molding apparatus according to claim 1, further comprising:
a cutting pin supported to be movable in the direction in which the cavity mold and the core mold are moved toward and away from each other in the core mold and configured to cut off the molten resin at an interface between the gate and the cavity; and
a receiving pin supported to be movable in the direction in which the cavity mold and the core mold are moved toward and away from each other in the cavity mold and having a central axis corresponding to a central axis of the cutting pin,
wherein the cutting pin cuts off the molten resin at the interface between the gate and the cavity when the molded hole is formed by cutting off the compressed part of the molten resin.

10. The molding apparatus according to claim 1, further comprising:
a cutting pin supported to be movable in the direction in which the cavity mold and the core mold are moved toward and away from each other in the core mold and configured to cut off the molten resin at an interface between the gate and the cavity; and
a receiving pin supported to be movable in the direction in which the cavity mold and the core mold are moved toward and away from each other in the cavity mold and having a central axis corresponding to a central axis of the cutting pin, wherein
the first slider is provided with a cutting-pin cam portion engaged to be slidable with respect to the cutting pin so that the cutting pin is moved,
the second slider is provided with a receiving-pin cam portion engaged to be slidable with respect to the receiving pin so that the receiving pin is moved,
the core pin and the cutting pin are configured to be movable simultaneously with each other in accordance with movement of the first slider,
the cavity pin and the receiving pin are configured to be movable simultaneously with each other in accordance with movement of the second slider, and
the cutting pin cuts off the molten resin at the interface between the gate and the cavity when the molded hole is formed by cutting off the compressed part of the molten resin.

11. The molding apparatus according to claim 1, wherein the part of the molten resin, which has been compressed and cut off, is formed as a cut-off piece, the cut-off piece being configured to be inserted in the molded hole by moving the core pin and the cavity pin and to be held in the molded hole.

12. The molding apparatus according to claim 11, wherein the cut-off piece held in the molded hole is configured to be taken out from the cavity together with the molded product.

13. The molding apparatus according to claim 1, further comprising a fixing sleeve formed into a cylindrical shape extending in the direction in which the cavity mold and the core mold are moved toward and away from each other, and having one axial end portion provided with an inclined surface forming portion which is inclined with respect to the direction in which the cavity mold and the core mold are moved toward and away from each other and which is configured to form an inclined surface with respect to the molded product, wherein
the fixing sleeve is fixed in one of the core mold and the cavity mold under a state in which the inclined surface forming portion is positioned in the cavity, and
one of the core pin and the cavity pin is supported to be slidable with respect to the fixing sleeve under a state of being inserted in the fixing sleeve.

14. A molding apparatus, comprising:
a cavity mold fixed at a predetermined position;
a core mold configured to be fitted against and clamped to the cavity mold so that a cavity in which molten resin is to be filled through a gate is formed;
a core pin supported to be movable in a direction in which the cavity mold and the core mold are moved toward and away from each other in the core mold and configured to form a resin compressed portion by compressing a part of the molten resin that has been filled in the cavity;
a cavity pin supported to be movable in the direction in which the cavity mold and the core mold are moved toward and away from each other in the cavity mold, having a central axis corresponding to a central axis of the core pin, and configured to form the resin compressed portion together with the core pin; and
a punch configured to be movable in the direction in which the cavity mold and the core mold are moved toward and away from each other and to form a molded hole in a molded product by cutting off the resin compressed portion, wherein
after the molten resin has been filled in the cavity, at least one of the core pin and the cavity pin is moved to be pressed onto the molten resin so that the part of the molten resin is compressed to be formed as the resin compressed portion before the molten resin is cured, and
the molded hole is formed by cutting off the resin compressed portion by the punch.

15. The molding apparatus according to claim 14, further comprising a slider which includes a cam portion engaged to be slidable with respect to the at least one of the core pin and the cavity pin so that the at least one of the core pin and the cavity pin is moved and which is supported to be movable in a predetermined direction in the at least one of the core pin and the cavity pin.

16. The molding apparatus according to claim 15, further comprising an urging spring configured to urge the at least one of the core pin and the cavity pin in a direction in which the at least one of the core pin and the cavity pin comes into contact with the cam portion of the slider.

17. A method of forming a molded product, comprising:
forming a cavity with a cavity mold fixed at a predetermined position and a core mold configured to be fitted against and clamped to the cavity mold;
filling molten resin through a gate into the cavity;
compressing a part of the molten resin by pressing at least one of a core pin and a cavity pin onto the molten resin before the molten resin is cured, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and
forming a molded hole by cutting off the compressed part of the molten resin by moving the core pin and the cavity pin.

18. A molded product obtained by:
compressing a part of molten resin by pressing at least one of a core pin and a cavity pin onto the molten resin before the molten resin is cured, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and
forming a molded hole by cutting off the compressed part of the molten resin by moving the core pin and the cavity pin.

19. A method of forming a molded product, comprising:
forming a cavity with a cavity mold fixed at a predetermined position and a core mold configured to be fitted against and clamped to the cavity mold;
filling molten resin through a gate into the cavity;
pressing at least one of a core pin and a cavity pin onto the molten resin before the molten resin is cured so that a part of the molten resin is compressed to be formed as a resin compressed portion, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and
forming a molded hole in a molded product by cutting off the resin compressed portion by a punch.

20. A molded product obtained by:
pressing at least one of a core pin and a cavity pin onto molten resin before the molten resin is cured so that a part of the molten resin is compressed to be formed as a resin compressed portion, the molten resin being filled through a gate into a cavity formed with a cavity mold fixed at a predetermined position and a core mold configured to be fitted against and clamped to the cavity mold, the core pin being supported to be movable in a direction in which the cavity mold and the core mold are moved toward and away from each other in the core mold, the cavity pin being supported to be movable in the direction in which the cavity mold and the core mold are moved toward and away from each other in the cavity mold and having a central axis corresponding to a central axis of the core pin; and
forming a molded hole by cutting off the resin compressed portion by a punch.
